(19) United States
(12) Patent Application Publication
(10) Pub. No.: US 2009/0198618 A1
(43) Pub. Date: Aug. 6, 2009

(54) DEVICE AND METHOD FOR LOADING MANAGING AND USING SMARTCARD AUTHENTICATION TOKEN AND DIGITAL CERTIFICATES IN E-COMMERCE

(76) Inventors: Yuen Wah Eva Chan, Wanchai (HK); Henry Fung, San Jose, CA (US)

Correspondence Address: PERKINS COIE LLP, P.O. BOX 1208, SEATTLE, WA, 98111-1208, US

(21) Appl. No.: 12/353,944

(22) Filed: Jan. 14, 2009

Related U.S. Application Data
(60) Provisional application No. 61/021,317, filed on Jan. 15, 2008.
(60) Provisional application No. 61/021,312, filed on Jan. 15, 2008.

(51) Int. Cl. G06Q 20/00; G06F 17/30; H04L 9/32; G06K 9/62

(52) U.S. Cl. 705/66; 705/35; 705/67; 705/44; 707/3; 705/71; 235/380; 707/E17.014; 707/E17.044

(57) ABSTRACT

Device, system, and method for loading, managing and using smartcard authentication token and digital certificates in e-commerce. System for making and accepting payments in on-line transaction between parties including transaction server coupled with storage device in which subscriber data structure is defined and stores transaction subscriber information and configured to communicate via network with certificate issuer and with card issuer. Computer implemented method for making and accepting payments in online transaction. Computer implemented method of issuing authentication certificate. Authentication token (smart card or SIM card) apparatus. Device for performing reading and/or writing operation to dual media smart card and SIM cards. Device, system, and method for using unique digital values to prevent fraudulent access or use of authentication token embedded with security digital certificate. System and method and business model for enabling payments to be made using Internet on secure basis using certificates and transaction facilitator payments portal.

### CROSS-REFERENCE TO RELATED APPLICATIONS

This application claims the benefit of priority under one or more of 35 U.S.C. §119 and 35 U.S.C. §120 to U.S. Provisional Patent Application No. 61/021,317 (Attorney Docket No. 67035-8001.US01) filed 15 Jan. 2008 and entitled System, Method, And Device For Loading And Processing Digital Certificates In Connection With Smart Cards For E-Commerce and to Provisional Patent Application No. 61/021,312 (Attorney Docket No. 67035-8002.US01) 15 Jan. 2008 and entitled Methods For Using Single Strong Authentication Token In Multiple-Purpose Online/Offline Electronic Transactions, each of which applications are hereby incorporated by reference in their entirety.

### FIELD OF INVENTION

This invention pertains generally to electronic commerce (e-commerce) and security systems, devices, methods and authentication tokens including smart cards associated therewith, the authentication tokens storing at least one electronic or digital certificate for authenticating the identity of a party involved in a transaction, and to infrastructure, methods, and business methods for conducting such transactions and commerce in a secure manner, and to a device and method for loading digital certificates onto a plastic card authentication tokens bearing an electronic chip for loading, storage and processing of digital certificates.

### BACKGROUND

Heretofore the paradigm has typically been to provide one authentication token, such as smart card, for one purpose or information or financial relationship. For example, the one authentication token may be provided for or identified with only one of a business-to-consumer (b2c) relationship, a business-to-business relationship (b2b), a government-to-consumer (g2c) or a consumer-to-Government (c2g), a consumer-to-consumer (c2c) relationship, or other single-purpose or multi-purpose relationships.

Furthermore, these authentication tokens, such as smart cards, do not implement or have any understanding of a concept of multiple rights.

In addition, although Public Key Infrastructure (PKI) is known in a general way, these conventional tokens, cards, or other instruments do not utilize PKI and are not PKI-based and therefore are limited in their applicability to many forms of commerce and electronic commerce. Subscriber Identity Module (SIM) cards may be a type of removable memory media, some being smart cards having an integrated circuit chip, and are frequently used for mobile or cellular telephony. They may also be used in various PDA devices or devices that combine PDA, telephony, and other information appliance features. Embedded SIM chips on plastic credit cards that are used for payment applications are also generally known but they do not include the PKI-based technologies into a widely circulated medium such as plastic credit cards, and they do not extend the latter to serve as security devices for enabling digital signature, encrypting data for transmission over wireless network, or other extended applications.

Conventional common credit cards or membership cards also are limited to have only ‘weak’ authentication in the form of a printed or embossed name and a photograph and do not provide for stronger authentication that is carried out by regulated agencies such as a government-recognized certificate authority or CA, or provide for the authenticated personal identification to be replicated in a secure and controlled manner on multiple cards serving different applications.

Other traditional forms of bank cards relied on magnetic stripe encoded information that was unreliable and subject to tampering. Writing to such magnetic stripe requires equipment that is not suitable to a typical end user or customer.

Furthermore, individual cardholders need to register his/her private information with the issuer, which will then print the information on the cards issued, and such individual card holders do not have control over implanting his/her individual unique digital certificate on as many cards or applications as desired and need to rely on others if such capabilities are to be provided at all. Issuance may require a face-to-face interaction, or make an assumption that a card sent by an institution to an end user or customer is actually received by that end user and not by an unintended different party. Activation of such cards may use only a weak personal identification number (PIN). Unfortunately, such cards may fall into the wrong hands or the membership or bank card number (such as a VISA® card number) may become compromised and transactions made with such cards my be repudiated by the card owner.

Even for conventional smart cards used in an online payment context where digital certificates have been involved in the transaction flow, such digital certificates have generally been used to authenticate the online identities of customers for enabling electronic banking (e-banking) and electronic stock or share trading (e-share trading) applications. For such use, the bank or securities house concerned would arrange for customers to be issued with digital certificates by a trusted independent third party such as a certification authority or CA. However, even in this context, the end user customer would have the personal responsibility of asking the CA to revoke their digital certificates if these become lost or if they believe any such digital certificates had been compromised or were being mis-used by unauthorized parties.

Even where smart cards having an integrated circuit chip which may include a processor and memory coupled to the processor are known, such known smart cards have not provided an end user consumer with an ability to write to or otherwise update or add to the stored contents or date of such smart card. Such conventional smart cards have at most permitted some read operation associated with a transaction. Writing to such smart cards has only been within the authorized capability of the card issuer (such as a bank issuing the card) or their authorized agent such as a company that manufactures the card for the bank.

Neither conventional bank smart cards nor the infrastructure in which they are distributed or used by end users do not provide any means for an end user to have any access rights to the contents stored in the card. More particularly, there is no means on the card or external to the card for the end user to have any write access rights to the card.

There is further need to provide system, device and method for writing to an authentication token, such as a smart card, to update, renew, modification, or add to information or data on the token when correct identify has been established and to provide means that may include software and/or firmware and hardware for performing the update, renewal, addition, or modification.

Finally, in certain legal jurisdictions, policies and laws may be developed now and in the future that provides for a legally binding and non-repudiatable online transaction mechanism that creates an additional need for digital or electronic certificate and infrastructure and method for using that certificate that provides for a positive identification, authentication, transaction non-repudiation, and the equivalent of a user payor and payee signature, even where the parties involved in the transaction have no prior relationship. There is also a need for an organization or entity to organize, facilitate, and operate such infrastructure and to participate in such transaction.

For these and other reasons, there remains a need for an authentication token, such as a credit card, debit card, identification card, or smart card or other media type having an electronic chip having processing logic and memory, or other token to be used for financial transactions, for non-financial transactions, or in other relationships between or among two, three or more parties where identification and authentication are required but where a known face-to-face relationship or meeting may not be possible or for other reasons. This need is particularly strong for use in online transactions. There is further a need for a process and method for implanting such digital certificates onto such authentication tokens, such as smart card based tokens, and for an inexpensive, small, and convenient device for individual cardholders and/or institutions to have and use. There remains an even further need for an on-line portal and portal operator that can assist in the safe and secure completion of transactions using these digital certificates, tokens, and methods.

### SUMMARY

In one aspect a device, system, and method for loading managing and using smartcard authentication token and digital certificates in e-commerce.

In one aspect, a system for making and accepting payments in an on-line network transaction between a first and second parties, the system comprising: an on-line networked transaction server coupled with a tangible storage device in which a subscriber data structure is defined and which stores transaction portal subscriber information; the transaction server configured to communicate via the network with an issuer of digital certificates and with an issuer of bank cards; the issuer of bank cards configured to communicate via the network and issuing bank cards having an integrated circuit defining a memory for storing a digital certificate and processing logic for protecting the memory from unauthorized access; and the issuer of digital certificates configured to communicate via the network and issuing digital certificates that are associated with a identifier (ID) and maintaining a certificate database storing issued digital certificates and digital certificate status.

In another aspect, there is a computer implemented method for making and accepting payments in an online network transaction, the method comprising: at a network on-line transaction portal, receiving a transaction instruction from a first party regarding an action to be taken relative to a second party; verifying with a certificate authority database in substantially real time that both the first party and the second party have currently valid digital certificates issued by a recognized digital certificate authority and associated with their unique identifier; verifying with a financial institution in substantially real time that the first party and the second party are capable of completing the transaction instruction; and maintaining an electronic transaction log to document the transaction and mitigate attempted repudiation of the transaction by the first party or the second party.

In another aspect, there is computer implemented method of issuing a digital security and authentication certificate, comprising: opening, by a certificate issuing authority, over a computer interface, an interface with a network server, to initiate a certificate issuance application; inputting an identification information of the applicant; generating a key pair including a private key and public key and an applicant specific digital certificate for the applicant; storing the digital certificate into a tangible computer or machine readable storage medium; and after successful issuance of the certificate, publishing the corresponding public certificate to a certificate repository.

In another aspect, there is an authentication token apparatus comprising: an integrated circuit having a processing logic unit and a storage unit coupled to the processing logic unit; a substrate for carrying the integrated circuit; the storage unit storing a certificate loader and control program comprising a plurality of certificate loader and control executable instructions; and the plurality of certificate loader and control executable instructions being operable to cause the integrated circuit to interact with the authentication token control manager (card control manager) executing in the computer or information appliance.

In another aspect, there is a device for performing a reading and/or writing operation for two objects each of which has a memory storage, the device comprising: a first physical connector for electrically interfacing with a first object or media type; a second physical connector for electrically interfacing with a second object or media type; a third physical connector for electrically interfacing with a third object; and a controller unit for enabling and controlling communications between the first, second, and third objects.

In another aspect, there is a method for using unique digital values to prevent fraudulent access or use of an authentication token embedded with a security digital certificate, the method characterized in that a cryptographic hash value of that ID includes hashing a unique user ID is stored on the token and when the internally stored hash is accessed by a user password or PIN, a comparison of the stored hash value against the user ID is made to determine a match before access is permitted.

In another aspect, there is a device for using unique digital values to prevent fraudulent access or use of an authentication token embedded with a security digital certificate, the device characterized in that a cryptographic hash value of that ID includes hashing a unique user ID is stored on the token and when the internally stored hash is accessed by a user password or PIN, a comparison of the stored hash value against the user ID is made to determine a match before access is permitted.

In another aspect, a system and method and business model for enabling payments to be made using the Internet on a secure basis using digital certificates and a payments portal.

In another aspect, a system and method for using unique digital values to prevent fraudulent access or use of an authentication token embedded with a security digital certificate.

In another aspect, a system and method for device that can deploy digital certificates stored using either the PKCS#11 and PKCS#12 file formats.

In another aspect, a device and system and method for use of a very small pocketable USB interfaced smart card and SIM card reader or reader/writer.

In another aspect a device and method for secure authentication token, such as a smart card or SIM card, providing secure protected end-user read and write capability for end-user renewal and reloading of security digital certificates associated with the authentication token owner.

These and other aspects will be appreciated from the detailed description and drawings which follow.

### BRIEF DESCRIPTION OF THE DRAWINGS

FIG. 1 is an illustration showing an exemplary embodiment of a first mutual authentication scenario or process in which a first party and a second party authenticate each other, and where although a third party is illustrated in the figure, the third party does not participate in authentication according to this exemplary scenario.

FIG. 2 is an illustration showing an exemplary embodiment of a second mutual authentication scenario or process in which a first party authenticates a second party through a third party, the first party authenticates the second party through the trusted third party, and the second party authenticates the first party.

FIG. 3 is an illustration showing an exemplary embodiment of a third mutual authentication scenario or process in which a first party and a second party authenticate each other through a trusted third party.

FIG. 4 is a illustration showing a non-limiting embodiment of a scheme for digital certificate storage in which a root certificate associated with first party may be stored in a storage, or alternatively or in addition, this root digital certificate may be stored in a data structure defined in a storage device controlled by the third party and adapted for storing one or a plurality of digital certificates.

FIG. 5 is an illustration showing a non-limiting embodiment of a closed loop secure e-commerce system that incorporates the inventive smart card including application loader (also referred to as the digital certificate loader) and digital certificate and advantageously uses a smart card reader unit in conjunction with authentication, non-repudiation, digital signing and encryption, and maintaining a transaction log for each transaction.

FIG. 6 is an illustration showing a block diagram of an embodiment of a system incorporating aspects of the present invention where a payor and the payee digital certificate could be a personal digital certificate, an organizational digital certificate, and/or a server digital certificate, that works within the close loop system.

FIG. 7 is an illustration showing an embodiment of a smart card incorporating aspects of the present invention.

FIG. 8 is an illustration showing the closed loop nature of the method according to an embodiment of the invention where the merchant certificate (or M-cert) may be a server certificate and the Transaction-Facilitator/portal may keep all the transactions logs, and/or electronic records as proof of the digitally signed commitment in the event of a dispute or attempted transaction repudiation.

FIG. 9 is an illustration showing aspects of the digital certificate issuance process as part of a system and process for implementing secure identification by converting a digital certificate issued from a recognized Certification Authority into one or multiple digital certificates on chips embedded in plastic according to an embodiment of the invention.

FIG. 10 is an illustration showing aspects of the digital certificate issuance process as part of a process for digital certificate issuance by a recognized certificate authority according to an embodiment of the invention.

FIG. 11 is an illustration showing a membership card (such as a bank card) issuance process according to an embodiment of the invention and the manner in which a unique digital value is loaded onto an authentication token such as a smart card using a special application loader or certificate loader to ensure that only the holder of the correct digital certificate can load his/her digital certificate onto that particular token or card.

FIG. 12 is an illustration showing a example of a card reader/writer having dual-card slots and associated electronic interfaces for receiving a electronic or digital file card and a smart card type authentication token such as a membership card, credit card, or the according to an embodiment of the invention.

FIG. 13 is an illustration showing a process for digital certificate suspension or revocation by a recognized certificate authority according to an embodiment of the invention.

FIG. 14 is an illustration showing a structure of a specialized hardware device, such as for example a USB interfaced hardware device, for interacting with a SIM card and a membership smart card according to an embodiment of the invention.

FIG. 15 is an illustration showing an external appearance of the special reader/writer device and shows a first slot for inserting a SIM card and a second slot for inserting a credit card sized smart card according to an embodiment of the invention.

FIG. 16 is an illustration showing a block diagram for the special USB smart card reader that is adapted for reading two card media types and as an internal memory.

FIG. 17 is an illustration showing an aspects of a card control manager (CCM) according to an embodiment of the invention.

FIG. 18 is an illustration showing a process flow for a customer seeking to access the payments portal via a digital certificate stored on a smart card according to an embodiment of the invention.

FIG. 19 is an illustration showing a process and function or certificate loading and key loading according to an embodiment of the invention.

FIG. 20 is an illustration showing a user interaction for card unblocking and loading application code onto card according to an embodiment of the invention.

FIG. 21 is an illustration showing an exemplary on-card application which shows a static structure of the card applications according to an embodiment of the invention.

### DETAILED DESCRIPTION OF EXEMPLARY EMBODIMENTS

Various examples, embodiments, and aspects are herein described relative to the figures and drawings.

In one aspect, embodiments may provide a system, technology infrastructure, device, and method that use a special payment portal and a digital certificate in combination with an authentication token to enable secure online transactions to occur. This advantageously includes a closed loop configuration where all parties that are involved in the online transaction are linked together in a particular way by digital or electronic certificates and have a relationship with a central party that may usually involve a payment portal operated by a payment portal operator.

In another aspect, embodiments may include a digital certificate structure stored on a tangible computer readable media that includes a unique numerical value or set of symbols, such as a security hash value of unique information, and that when used in conjunction with protective software or firmware executable code on the tangible media, permits some authorized writing to the media but prevents all non-authorized writing to the media. The tangible media may advantageously be a smart card type media where the executable code is store in a memory of the smart card and executed by a processor or processing logic within the smart card. The executable code is operative to control what may be read from and written to the media, and in particular is operative to query and verify the identity of a person or organization associated with the media and to authenticate such identity before permitting operations to the media, particular to write to the media or smart card.

In another aspect, embodiments provide for an authentication token such as a smart card type bank or membership card that permits not only an issuing institution but also an end user or customer (when properly identified and authenticated) to securely write a digital certificate to the token or card after an electronic identity match, thereby eliminating the need for the token or card to be reissued when digital certificates reach an expiration date.

In another aspect, embodiment of the invention provide an authentication token structure and method of use, as well as a system and method for performing secured online and/or offline transactions that may involve two, three, or more parties or entities. Using a single authentication token (such as, but not limited to a smart card) the authentication token or card holder may perform any one or more of many different kinds of transactions with different rights and/or restrictions applying to the different kinds of transactions and therefore to the transactions themselves as specified by the digital certificates. Embodiments provide for the electronic or digital certificates to be stored either in the authentication token or in a different device or location, such as on a separate server. Within this authentication environment or ecosystem, all parties or entities share a secured platform in a trusted environment.

In another aspect, embodiments of the invention provide special software or firmware embedded on the authentication token or smart credit/debit card chip that only allows the cardholder's unique electronic or digital certificate(s) and no one else's certificate(s) to be loaded onto that chip. In some regions such as in Hong Kong, we are able to do this easily because everyone's unique Government-issued ID card number can be matched algorithmically to his/her digital certificate organisation variable (OV) number.

In another aspect, embodiments of the invention provide special software installed on one or more web-sites of participating on-line merchants that automatically check the validity of a cardholder's digital certificate once he or she has deployed it before permitting a transaction payment to be processed. For example, an on-line “Black List” could be updated once every 6 hours, daily or at other predetermined or dynamically determined interval, or by using an Online Certificate Status Protocol (OCSP) alert which may be used to obtain an immediately updated blacklist or invalid certificate update for high value customers or transactions. Aspects of OCSP are described in the X.509 Internet Public Key Infrastructure standard in effect at the date of filing this application and incorporated herein by reference.

In another aspect, embodiments of the invention provide a capability for this web-site based software to enable the automatic generation of an e-mail receipt back to the cardholder after every transaction.

In another aspect, embodiments of the invention provide special a USB-compatible or other interface compatible card reader to enable a digital signature to be deployed on virtually any Microsoft Operating System enabled PC by plugging the authentication token or smart credit/debit card into the side slot and launching the electronic or digital certificate thereby enabling a person carrying his/her smart credit/debit card and this card reader the ability to perform on-line or off-line transactions virtually in the same manner anywhere and at anytime.

In another aspect, examples provide a system and method and business model for enabling payments to be made using the Internet on a secure basis using digital certificates and a payments portal.

In another aspect, examples provide a system and method for using unique digital “values” to prevent fraudulent access or use of an authentication token embedded with a security digital certificate.

In another aspect, examples provide a system and method for device that can deploy digital certificates stored using either the PKCS#11 and PKCS#12 file formats, wherein in one non-limiting example, this device may be very small pocketable USB interfaced reader or reader/writer.

In another aspect, examples provide a device and method for secure authentication token, such as a smart card or SIM card, providing secure protected end-user read and write capability for renewing security digital certificates associated with the authentication token owner.

A digital signature or digital signature scheme is a type of asymmetric cryptography used to simulate the security properties of a signature in digital form. Digital signature schemes provide use of two algorithms, a first algorithm for signing which involves the user's secret or private key, and a second algorithm for verifying signatures which involves the user's public key. The output of the digital signature process is referred to as the digital signature.

Digital signatures are used to provide authentication of the associated input document or message. Messages may be anything, from electronic mail to a contract, or even a message sent in a more complicated cryptographic protocol. Messages may pertain to transactions between parties or entities. Digital signatures are for example, used to create public key infrastructure (PKI) schemes in which a user's public key (no matter whether for public-key encryption, digital signatures, or any other purpose) is tied to a user by a digital identity certificate (or more simply a “digital certificate” or an “electronic certificate” or some variation or abbreviation of these) issued by a certificate authority or CA. Such PKI schemes attempt to unbreakably bind user identity information (name, address, phone number, social security number, government ID, or other identity information) to a public key, so that public keys can be used as a form of identification.

As known in the art, a digital signature scheme involving public-key cryptography typically consists of three algorithms: a key generation algorithm, a signing algorithm, and a signature verifying algorithm. The key generation algorithm (G) randomly produces a verifying key (PK) and signing Key (SK) “key pair” (PK, SK) for the signer. The verifying key (PK) is intended to be public, and the signing key (SK) is to be kept private or secret.

The signing algorithm (S) on input of a message (m) and a signing key (SK), is operative to produces a signature (a). The signature verifying algorithm (V) on input of the message (m), the verifying key (PK), and the signature (σ), is operative to either accept or reject it. This scheme may usually rely or attempt to rely on assumptions that (1) signatures computed honestly should always verify, or in other words that the signature verifying algorithm V should accept the set (m, PK, S (m, SK)) where SK is the secret key related to PK, for any message m: and (2) that it should be hard for any adversary knowing only PK, to create any valid signature.

Authentication includes a process or procedure for establishing the identity of the party, entity, or source of a message or transaction. Although messages including for example messages associated with transactions between two, three, or more parties may often include information identifying or suggesting something about the entity purporting to be sending the message or involved in the transaction, that information may not be accurate. Digital signatures can be used to authenticate the source of messages and therefore something about the true identity of the message source.

When ownership of a digital signature secret key is bound to a specific user, a valid digital signature shows that the message was sent by that user. The importance of high confidence in sender authenticity is especially obvious in a financial context whether involving transfer of monetary funds directly or associated with the sale or transfer of goods or services having a monetary value.

In addition, the sender and receiver of a message may have a need for confidence that the message has not been altered during transmission. Encryption alone may conceal the contents of a message, but it may be possible to change an encrypted message even without understanding it. When a message is digitally signed, any change in the message will invalidate the digital signature, and there are presently no known efficient ways to modify a message and its signature to produce a new message with a valid signature, because this is still considered to be computationally infeasible by most cryptographic hash functions.

As know in the art, public key-private key cryptographic systems and methods depend for security on keeping the private key secret. A private key can be stored on a user's computer or other information appliance, and protected by, for instance, a local password, but this has at least two disadvantages. First, the user of the key pair can only sign documents or perform transactions that are on or conducted through that particular computer. Second, the security of the private key depends on the security of the computer, which is notoriously unreliable for many PCs and operating systems, in a time of spy-ware, hackers, virus, and other so called malware, not to mention sheer carelessness.

A more secure alternative is to store the private key on a so called smart card, chip card, integrated circuit card (ICC), or the like. A smart card, chip card, or integrated circuit card (ICC), is typically a pocket or wallet-sized card with embedded integrated circuits which can store and process information. Often such cards are the size of traditional credit cards and further include an electronic chip or integrated circuit. Such smart cards can receive one or more inputs which may be processed by way of the ICC application(s) and delivered as an output. There are two broad categories of smart cards, chip cards, and ICC cards. Memory cards contain only non-volatile memory storage components, and perhaps some specific security logic. Microprocessor cards contain volatile memory and microprocessor components. Usually the cards are made of plastic. The card may include other security features as signs of authenticity such as embed hologram to avoid or at least increase the cost of counterfeiting.

Smart cards are either contact type of contact-less type. Contact smart cards usually have a small gold chip about 1-cm square on their front surface. When inserted into a reader, the chip makes contact with electrical connectors that can read information from the chip and write information back to it. The ISO/IEC 7816 and ISO/IEC 7810 series of standards define smart card physical shape, positions and shapes of the electrical connectors, electrical characteristics, communications protocols that includes the format of the commands sent to the card and the responses returned by the card, robustness of the card, and functionality. Such cards do not contain batteries or other stored energy source and energy is supplied by a card reader.

Contact smart card readers are often used as a communications medium between the smart card and a host, such as a computer, a point of sale terminal, or a mobile telephone. Contactless smart card represents a second type. In these cards, the chip may communicate with a card reader through Radio-Frequency Identification (RFID) induction technology. These cards only require close proximity to an antenna to complete a transaction. There are also dual-interface cards that implement contactless and contact interfaces on a single card with some shared storage and processing.

Many smart cards are deliberately designed to be tamper resistant. In a typical implementation, the hash calculated from a document is sent to the smart card, whose integrated circuit CPU or processor encrypts the hash using the stored private key of the user and returns it. Typically, a user must activate his smart card by entering a personal identification number or PIN code (thus providing one form of a two-factor authentication). Note that it can be sensibly arranged that the private key never leaves the smart card. If the smart card is stolen, the thief will still need the PIN code to generate a digital signature. This reduces the security of the scheme to that of the PIN system, but is nevertheless more secure than are many PCs.

Entering a PIN code to activate the smart card commonly requires a numeric keypad. Some card readers have their own numeric keypad. This is safer than using a card reader integrated into a PC, and then entering the PIN using that computer's keyboard. The computer might be running a keystroke logger so that the PIN code becomes compromised. Specialized card readers are less vulnerable, though not invulnerable, against tampering with their software or hardware.

In one aspect, embodiments of the invention provide a process for implementing secure identification by converting a digital certificate issued from a recognized Certification Authority (CA) upon proper authentication of an individual, advantageously using a PKCS#12 format (also cater to Apple Macintosh computers, which may not have a certificate store like Microsoft Operating System based systems typically have), into one or multiple digital certificates, again advantageously in PKCS#11 format embedded in plastic cards. The PKCS#11 format which may provide a more secure format, once the PKCS#12 (file) format is imported into the chip, because the then the PKCS#11 format file cannot be copied out again and reused in a different context. These plastic cards may advantageously be plastic cards having an electronic or computer readable storage and possibly processing logic, such as may be found in smart cards having a integrated circuit chip carrying a processing logic coupled to at least one memory.

Non-limiting embodiments of the inventive system, method, and/or authentication token may involve two or three parties. In the examples, involving three parties, the first party is normally the holder of the authentication token, the second party is the party that the first party normally wants to interact with for the transaction, and the third party is a trusted entity normally known as the Certificate Authority (CA).

In at least one non-limiting embodiment, a two factor authentication is used to verify the user's identity.

The authentication token (e.g., smart card) contains or stores the root certificate. In one non-limiting embodiment, the root certificate is compatible with the Public Key Infrastructure (PKI) standard. This root certificate is generated by the third party that the authentication token holder (for example, the smart card older or more simply card holder) has established a relationship with.

Typically, a root certificate is part of a public key infrastructure scheme and may be either an unsigned public key certificate or a self-signed certificate. The most common commercial variety of a root certificate is based on the ITU-T X.509 standard, which normally includes a digital signature from a certificate authority (CA). A certificate authority may issue one or may issue multiple certificates and these may be in the form of a hierarchical or tree structure. The root certificate is the top-most certificate of the tree or hierarchy. All certificates below the root certificate in the tree or hierarchy are understood to inherit the trustworthiness of the root certificate, and many computer or information software applications assume these root certificates are trustworthy on the user's behalf.

Optionally, but advantageously, the system, method, and authentication token permits mutual authentication performed via the third party, such as by utilizing storage, processing capability, memory and/or other resources on a third party server. This is not required but may be advantageous, particularly in situations there may not always be not enough resources on the first party's token (or on or within the resources of another party such as the second party, involved in the transaction) to perform the authentication. In his situation, the third party server (or server certificate) may act as a proxy for the first party (or the second party) authentication token (such as the smart card) to authenticate the second party.

Various transactions are now described, some involving two parties and others involving three parties in different ways. Prior to performing or being involved in these transactions, in accordance with one non-limiting embodiment, a first party (normally the holder of the authentication token) may obtain one or more digital certificate(s) in any one or more of various tangible electronic or computer or machine readable formats and/or media and transfer the digital certificate(s) to the tangible authentication token for storage and for later use directly without intervention of the PC to avoid security breaches, spying or copying, or various other treats or loopholes. An authentication token reader, such as a smart card reader, may be utilized to read information from and write information to the authentication token. Example, optional embodiments of a special authentication token ready that may be used to read the token and are described elsewhere herein.

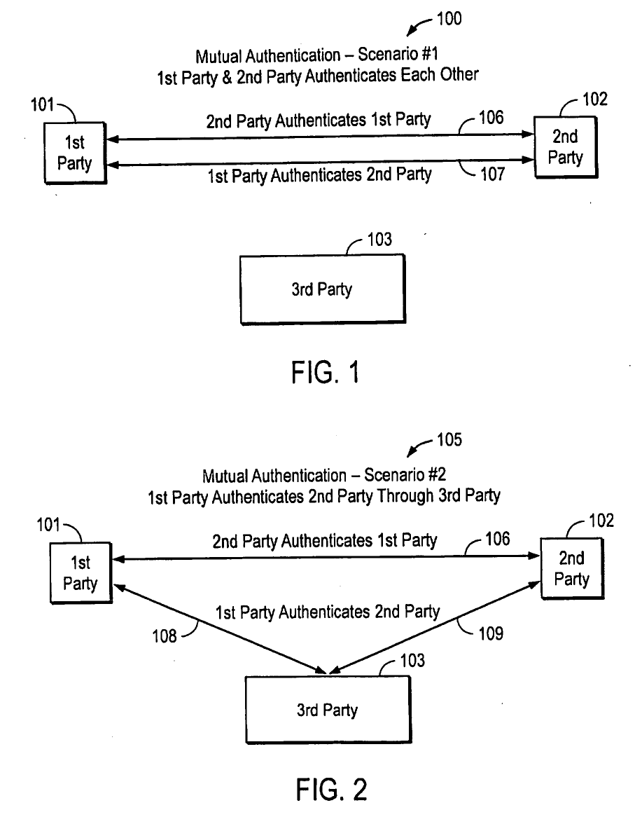

FIG. 1 illustrates an exemplary embodiment of a first mutual authentication scenario or process 100 in which a first party 101 and a second party 102 authenticate 106, 107 each other. Although a third party 103 is illustrated in the figure, the third party does not participate in authentication according to this exemplary scenario. Usually the first party may be the payor (or payer), that is the person or other entity who is responsible for making a payment to a payee. In this situation, the second party who receives the a payment from the payor.

FIG. 2 illustrates an exemplary embodiment of a second mutual authentication scenario or process 105 in which a first party 101 authenticates 108 a second party 102 through a third party 103. In this non-limiting embodiment, the first party 101 authenticates 108, 109 the second party 102 through trusted third party 103, and the second party 102 authenticates 106 the first party 101.

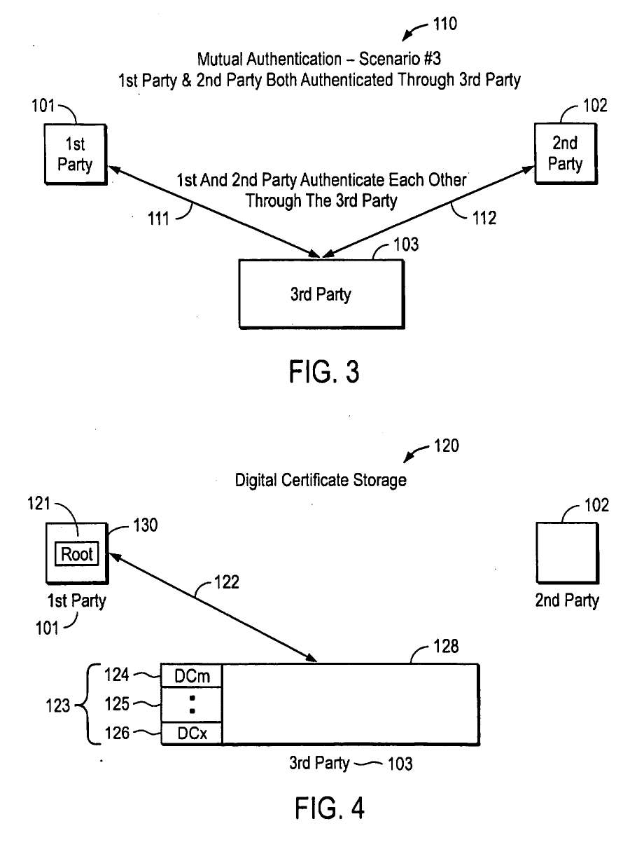

FIG. 3 illustrates an exemplary embodiment of a third mutual authentication scenario or process 110 in which a first party 101 and a second party 102 authenticate 111, 112 each other through a trusted third party 103.

In at least one non-limiting embodiment involving a third party, the inventive system, method, and authentication token is operative to provide a notification to a first party from the third party for each transaction via electronic communication means or by other communication or information transmission or notification means. For example, an email message may be sent by the third party to the first party, or a text message may be generated and sent using cellular telephone based text messaging or in other ways known in the art. Advantageously, the first party may additionally receive (such as for example, from the second party or from the third party) a full statement of all activities associated with each transaction no matter if it is a transaction involving funds or money going out or coming in. Associating the (or each) digital certificate associated with some pre-determined or dynamically determined rights and/or restrictions may for example be advantageous.

In at least one non-limiting embodiment, the digital certificates according to embodiments of the invention may be multi-purpose digital certificates that allow and facilitate transactions between different parties or sets of parties using the same authentication token, such as a smart card. A business to consumer to government (b2c2g) transaction may be authenticated using the same token in this way.

Various types of rights and/or restrictions may be associated with each digital certificate. These may be categorized in a variety of different ways and in different combinations. The categorization described below in exemplary and not limiting. In one non-limiting categorization, there are at least two types of rights/restrictions that include: (a) first party (token or card holder) rights and/or restrictions, and (b) second party rights and/or restrictions.

By way of example and not of limitation, the first party rights and/or restrictions may include such items as: (i) how much money can be drawn from the user's bank in a business to consumer (b2c) transaction, (ii) how many books a user can still borrow from the library in a government to consumer (g2c) transaction, (iii) that a government allowance cannot be used to buy liquor in a government to consumer (g2c) transaction, or (iv) whether the user or holder has a right to access certain documents, enter particular facilities or rooms of a building, or log in to particular computer network, or view particular web or information content, or the like in a business to business (b2b) transaction. These examples are not limiting and it will be appreciated that they are merely illustrative and that an almost endless variety of two-party, three-party, and multi-party rights and restrictions possible.

By way of example and not of limitation, the second party rights and/or restrictions may include such items as: (i) can the second party (such as for example, a merchant) charge the first party for certain service as specified by the digital certificate from another second party (such as for example, the government) in a business-to-consumer-to-government (b2c2g) transaction; or (ii) does the second party have the right to accept money or benefit from the first party due for example to fake or fraudulent identity of the second party or wrongful transfer made by the bank or first party or in other words, to make sure one first party is transferring money to the other first party correctly in a consumer to consumer (c2c) transaction.

In at least one non-limiting embodiment, the inventive system, method, and authentication token is operative to prevent fraud on each side of a two-way transaction or on transactions involving a plurality of parties, such as but not limited to transaction involving three or more parties.

FIG. 4 is an illustration showing a non-limiting embodiment of a scheme 120 for digital certificate storage. A root digital certificate 121 associated with first party 101 may be stored in a storage 130. Alternatively or in addition, this root digital certificate 121 may be stored in a data structure 123 defined in a storage device 128 controlled by the third party 103 and adapted for storing one or a plurality of digital certificates DCm, . . . , DCx 124-126 where m and x are integers.

An authentication token may take any physical or logic form. Usually the authentication will include a physical memory device for storing at least one digital certificate and will include some security device, circuits, logic or other hardware, firmware, and/or software security means to protect the digital certificate(s) from unauthorized access or compromise. Such security means may include for example, password or Personal Identification (PIN) number access features as are known in the art. These may cooperate with the security device hardware to enable or deny access or use. Therefore in addition to a smart card type of authentication token, the authentication token may usually be embodied in any electronic or computer device or appliance, and/or in a tangible computer readable device or medium, that includes non-volatile memory and some processor logic or processing means for accessing the memory storing the authentication token and advantageously for performing an authentication process either by itself or in conjunction with a third party , such as in a third party server, as described elsewhere herein.

In at least one non-limiting embodiment, multiple digital certificates may be associated with or bound to a single authentication token. Furthermore, each digital certificate may be associated with some predetermined or dynamically determined rights and/or restrictions. Having multiple digital certificates associated with or bound to a single token may be advantageous.

It may be appreciated that a single certificate may be installed in multiple different authentication tokens. For example, copies of the same certificate may be installed in a smart card issued by a banking or financial institution, in a government issued identification (ID) card, in a cellular telephone, in an other information device or appliance, or the like. Other parties or entities may also generate electronic or digital certificates but the generation of certificates and/or the generated certificates should be approved or be on the approval of the trusted third party that generated the root certificate.

In at least one non-limiting embodiment, the digital certificate is generated for a specific physical authentication token only and cannot be loaded into another different physical authentication token. Where the authentication token is for example, a smart card, the digital certificate or certificates are generated only for that particular smart card. Other non-limiting embodiments may permit and facilitate loading of digital certificates onto other physical tokens or media.

In at least one non-limiting embodiment, these digital certificates may be deposited in the authentication token such as in the smart card. In other non-limiting embodiments, these digital certificates may also or alternatively be deposited in a storage device or means of the trusted third party, such as in storage of the third party's server, particularly if the authentication token, such as the smart card, does not have enough storage. The third party server may also be used to assist in processing a transaction using the digital certificate especially if the authentication token does not have sufficient processing resources. This third party participation in the transaction may be provided even if the authentication token has sufficient resources to store the digital certificate.

In at least one non-limiting embodiment, it may be understood in light of the description provided here, that although structure and method have been described for issuing, storing, accessing, using, and otherwise manipulating the digital certificates, any particular ones or all digital certificates that have been issued may later be suspended, cancelled, or revoked. When so suspended, cancelled, or revoked, an indication of the suspension, cancellation, or revocation may be stored with the digital certification, and/or the digital certificate may be removed or erased from the storage media on which it had previously been stored.

When the authentication token is or includes a smart card or smart card type electronic chip or circuit, it may be appreciated that some smart cards may not have sufficient resources (such as processing power, memory, or a combination of processing power and memory) to perform the so called mutual authentication, particularly if the mutual authentication is somewhat processor and/or memory burdensome as may be the situation with PKI mutual authentication. Mutual authentication is a process by which the at least two parties involved in the transaction are authenticated to each other. Mutual authentication of PKI may involve substantial computational processes relative to the processing resources available on a smart card, particularly where the chip and electronics of the smart card are designed to be relatively inexpensive for a mass consumer or user market. When three or more parties are involved in the transaction, the mutual authentication may extend to and be between and among all of the involved parties.

In conventional electronic or e-transactions, the authentication may usually be only a one-way authentication wherein only one of the two parties involved in the e-transaction are authenticated and the other one of the two parties are not authenticated. This represents a disadvantageous compromise and possible repudiation or non-repudiation situation, but may necessarily be acceptable because otherwise the transaction between the two parties may not be possible. Therefore non-limiting embodiments advantageously provide for a mutual authentication, and even more advantageously and preferably may involve a trusted third party to lessen the probability that a transaction will be disavowed or repudiated by a party (such as the first party in the examples here).

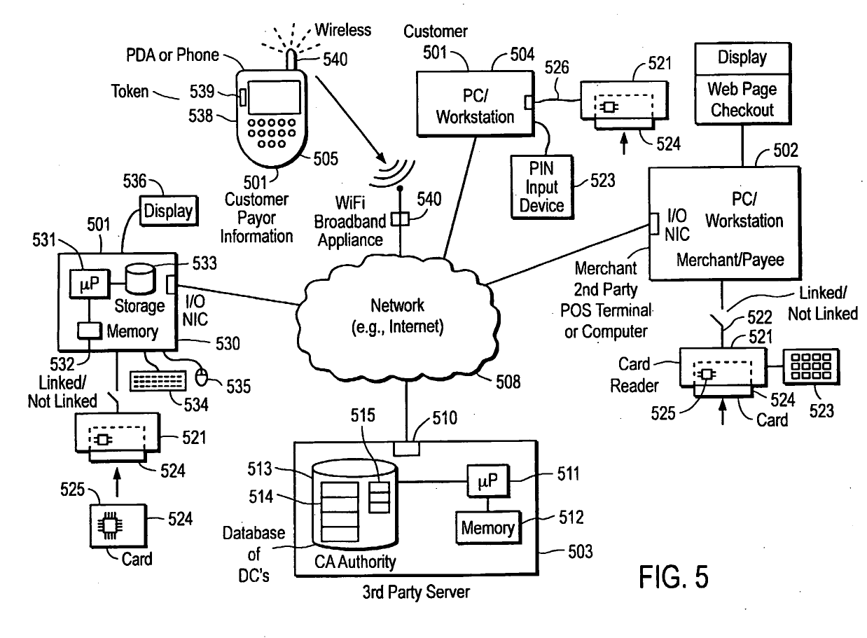

With reference to FIG. 5, there is illustrated an example of a secured e-commerce environment that may be used with aspects of the present invention. This operating environment is able to support multiple device types including at least one server and a plurality of different client devices or subsystems. This example embodiment includes at least one merchant 502 usually acting as a transaction payee, at least one customer 504, 505 usually acting as transaction payor, a recognized digital or electronic certificate authority 503 usually acting as a neutral third party to support security features and maintain the integrity of the transaction, and at least one payment portal or bank 501 that is responsible for authenticating the identities of the consumer and merchant and for transferring payments and maintaining transaction records. It may be appreciated that in an actual deployment, there may be a plurality of payment portals or banks 501 and that these portals or banks would have agreements respecting the verification and transfer of funds between the different accounts that may be owned by different customers or consumers and different merchants or other providers. It may also be appreciated that a merchant entity may itself be a payment portal or bank, and may for example operate to move funds from one user account to a different account by the same user or a different user. A bank may also operate to move funds or make payments to a bank or other financial institution in conjunction with a stock or security purchase or sale. In this sense, a one bank or financial institution may also operate as a consumer. Therefore the labels applied to the different entities, servers, and portals are for illustrative purposes and not limitations themselves.

In one aspect, the embodiment of the system in FIG. 5, illustrates an operating environment that shows the ability of various payors to access the Internet and other entities coupled to the Internet on a secure basis via a computer personal digital assistant (PDA), notebook computer, cellular telephone, or other information appliance, and to connect to or interact with the other devices and subsystems connected to the Internet. As described herein elsewhere, the ability to conduct a secure online transaction according to the invention with these access devices requires a computer, personal digital assistant (PDA), notebook computer, cellular telephone, or other information appliance that has been built or modified to include additional features, or that is operated with a peripheral device that is adapted for at least reading a special authentication token carrying media, such as a digital certificate carrying smart card, during an e-commerce transaction. In some non-limiting embodiments, the a computer personal digital assistant (PDA), notebook computer, cellular telephone, or other information appliance 501 may also include or be built or modified to include additional features, or that is operated with a peripheral device that is adapted for also writing to the special authentication token carrying media or digital certificate carrying smart card. However, the ability to write to the token or card is optional for providing additional operational and convenience features and is not required of all embodiments.

These systems and methods therefore limited the manner in which digital certificates could be used to transactions which had a prior relationship and where known to each other through that relationship. Non-limiting embodiments of the present invention extend the use and applicability of digital certificates to enable transactions, including for example payments, to be made between and amongst parties, within a secure online system environment or ecosystem of FIG. 5 that is supported by or involves the participation of one or more recognized certificate authorities, where the parties involved in the transaction or payment, do not or may no have prior relationship with one another. This aspect significantly extends the range of transactions that may be supported as compared to known systems and methods.

The server computer or computer system 503 operated by a recognized certificate authority (CA) is coupled to a network 508, such is for example an Internet network 508, and may include a processor 511 coupled to memory 512, each of which may be coupled to a storage database 513 for storing data or other information including digital certificates 514 and information or data concerning the current status of such certificates, such as an active valid status, a suspended status, a revoked status, an expired status, or other status as may be convenient to maintain. The revoked status of digital certificates may be maintained as a certificate revocation list (CRL). The status of the certificates (whether with or without a CRL) may be maintained and stored on storage device 513 as a data structure or list or in a Lightweight Directory Access Protocol (LDAP) repository 515.

This CA server is referred to in some embodiments as the third party server because of the type of interaction it has and the services it provides to the first party and second party described elsewhere herein relative to a transaction involving two parties (such as a buyer and merchant, or payor and payee, and the like) and the authentication token (e.g. smart card), digital certificates, and so forth. In one non-limiting embodiment, the database 513 is formed or instantiated on a hard disk drive 513 or other mass storage device. The hard disc drive may also store software such as for example operating system software, application program software, server support software, security software, and/or other software for use in implementing the features of the inventions described herein and for operating server 503.

For example a participating merchant site or server 502 (or other goods or service provider such as for example, a utility company, government entity, or other business or non-business entity), may have a web site, e-commerce site, or other network accessible portal on the Internet where the goods and/or services are offered. A consumer operating from a consumer access device 504 may know the merchant's side or be browsing the Internet and locate the merchant's site 502. It is not important if there is any prior direct relationship between the consumer or merchant or between the consumer access device 504 and the merchant site or server 502.

The merchant computer 502 may further have coupled to, such as via a serial bus connection, or USB connection 522, or by other communications link, a reader of the type described elsewhere herein that is adapted to read the inventive authentication token storing media. One example or an authentication token described here is a digital certificate provided by a recognized certificate authority body that is stored in a memory of a smart card. In this instance, the reader is a smart card reader that includes a first slot or other connection means for coupling with and communicating with a smart card 524 that has an embedded semiconductor integrated circuit chip 525 that includes the processing logic memory and other features as described elsewhere in.

The same card reader 521 may optionally include a second slot or means for coupling with another memory device 523 such as a SIM card or other memory device. Whether including a single card or media slot or two card or media slots, the reader may optionally but advantageously provide an ability to write to the data or information stored in one or both cards or media types. Optional embodiments that provide for two or more media or card slots may provide for the copying or transfer of information between the cards as described elsewhere herein.

It may be appreciated that the consumer may connect to the Internet via any of a variety of devices and the illustration in FIG. 5 illustrates a plurality of other devices or subsystems that may be coupled to the network and via such network to other clients and/or servers.

For example, the system in FIG. 5 may also or alternatively include a device or system 504 such as a computer that includes a peripheral device 521 capable of reading an authentication token 524, such as a smart card 524. That peripheral device 521 may couple to computer 504 via a USB connection, a serial connection, or other communication link as is known in the art. Computer 504 may also include a personal information number (PIN) or password (PW) input device 523 such as a keypad or keyboard. Input device 523 may couple with computer 504 via any known connection or communication link such as via a USB cable, serial cable, parallel cable, or other wired or wireless connection. Advantageously, the connection between the PIN input device 523 and the computer 504 will be such that it is a secure connection so that pin number cannot be intercepted and compromised. As described elsewhere herein, the entry of a PIN or PW may be required during an on-line e-commerce transaction when providing an identity and authenticating one's identity using the digital certificate. When the access device is a PDA or cellular telephone, keypad may be the typical keypad on such device. If the access device is different type of information appliance, such as a network connected television or entertainment system, the entry device may be any device available for that system, such as a remote control unit having a keypad.

In the alternative, a cellular telephone, PDA, computer, or other information appliance having a wireless connectivity capability 540 may couple to network 508 via a wireless receiver that is coupled to network. The wireless connectivity may for example be a WiFi connection, a broadband connection, a WiMAX connection, or other wireless radio-frequency or optical-frequency connection known in the art or to be developed. The device 505 may include an authentication token such as a digital certificate 539 stored within the device.

The structure and operation of some of the consumer network access devices may vary from device type to device type. For example, for a desktop type personal computer or notebook computer 504, interaction with the smart card may advantageously take place with an electrically connected or tethered smart card reader that is connected to the computer during the transaction. However, when the consumer access device is a cellular telephone or PDA 505, although operation with a wired or tethered card reader may be used, it may be more convenient to incorporate the functions and capabilities of the card and card reader (an optionally the card reader/writer) into the cellular telephone or PDA. For example, certain cellular telephones include a SIM card that include cellular telephone subscriber information. In some non-limiting embodiments of the invention, the special SIM card may be used to store the digital certificate and the application loader or certificate loader and the electrical and logic circuits in the cellular telephone adapted to perform the functions and operations described here relative to a smart card reader (and optionally a reader/writer). References to application loader herein are synonymous with certificate loader.

In this example, it is assumed that the consumer has identified some goods and/or services and wants to complete a transaction involving a payment for the selected goods and/or services. In this example, the customer is referred to as the first party and payor and the merchant is referred to as the second party and payee.

Finally, the example system of FIG. 5 illustrates a further payment portal or bank subsystem, such as a server computer 501 having a processor, microprocessor or other processing logic 531 and memory such as RAM 532 coupled to the processor 531 and a mass storage device such as a hard disk drive 533 coupled to the processor and memory in conventional manner. Payment portal or bank computer 501 may also advantageously include an input/output (I/O) connection such as a network interconnect card (NIC) for coupling computer 501 to the actual network 508 as would the other network access devices described here. Conventional human interaction devices such as keyboard 534 and mouse 535 may be coupled to the computer 501 and a display device 536 such as are known in the art may be included. Computer 501 may also include a card reader device 521 for interacting (e.g., reading and/or writing) with smart card 524 that includes an electronic integrated circuit chip 525. In one non-limiting embodiment, the card reader/writer may be used for issuing a smart card to a consumer or merchant with the appropriate consumer or personal digital certificate or merchant digital certificate. The payment portal or bank may also have additional software and access rights in order to reset a smart card PIN or PW, or for reissuing a smart card with a new digital certificate stored therein. It may also be appreciated that the payment portal or bank may operate server computer and at least one other client computer and that the interactions between the payment portal or bank and the network may be though different physical computers or terminals than are used for interacting with customers when issuing cards, resetting cards, or other such direct customer interactions.

The payments portal organization, which may be a bank or other financial institution, is responsible for the online payments portal operation and may usually enter into a contract separately with each payor and payee. Typically there are many payors and many payees that will utilize the payments portal. Each payor would contractually agree for the payments portal organization or bank or with different payment portal organizations or banks that agree to cooperate, and recognize and facilitate the transaction, such as for example, to debit a designated bank or credit card account of the payor upon the payment portal's receipt of his/her online payment instruction supported by the payor's (his/her) digital signature. The payor's digital signature being generated by his/her valid digital certificate that was pre-registered with the payments portal. Analogously, every payee would contractually agree to accept payments made by payors through the payment portal, and to pay the payments portal a fee for receiving payments from payors. In some non-limiting embodiments, the payment of a fee by the payee to the payments portal may be waived or eliminated, but it is typically expected that such fees or other financial remuneration or incentive would be involved.

The payment portal is configured to check the status of a digital certificate on the CRL server database before giving accepting and giving effect to every payment instruction received from a payor. If the digital certificate is valid the payment is authorized and the transaction between payor and payee approved. If the digital certificate appears on the suspended or revoked list in the CRL database, the transaction (e.g. payment) will not be approved. The payor may then optionally be given alternative ways to complete the transaction, that do not involve the particular suspended or revoked digital certificate.

In one non-limiting embodiment, this payment portal or bank 501 may be operated by a government or public entity, such as a tax payment portal or a utility company portal and when account information is available from some relevant identifier for the consumer, the system may advantageously use unique digital value or sequence of symbols to simplify the registration process of payors and the payment process itself. For example, the customer may enter their national identity number to a government tax payment agency and have presented their tax bill for payment. Because such unique digital values also have the ability to authenticate each person's (or each entity's) electronic or on-line identity, the system and method permit access to some, selected, or all of that person's or entities information that was submitted to or filed with the Certificate Authority. This feature advantageously but optionally permits the system and method to assist the person or entity in providing or pre-filling a significant amount of that person's or entity's personal information. For example, it may assist in providing a person's full legal name, email address, residence address, tax bill, utility bill, and or other information.

Various transaction scenarios are described that involve a certificate authority (CA), a payments portal or bank, and at least two other parties, a payor and payee. It may be appreciated from the detailed description set forth here, that both of the latter (the payor and the payee) should have contracted with at least one payments portal or bank before these various transactions can be implemented. Where payee and payor have contracted with different payment portals or banks, there may usually be agreements between the different payment portal organizations or banks so that the transactions may still be accomplished when they have access to the digital certificate authority database for verifying an active status of payee and payor digital certificates.

In understanding some of the novel aspects of the system and method described, it may be noted that heretofore in a payments context, digital certificates have been used in limited circumstances to authenticate the online identities of customers for enabling e-banking and e-share trading applications. For such use, the bank, securities house, or other institution concerned would arrange for their customers to be issued with digital certificates. However, the digital certificates were not stored on smart cards or in other convenient form for use in the same way described herein, nor were there closed loop verification and authentication schemes provided for conducting secure online transaction in the manner described. Furthermore, when digital certificates were available, such customers would have the responsibility of asking the certificate authority to revoke their digital certificates if these (or the card or media carrying them) become lost or if they believe any such certificates are being mis-used by unauthorized parties. In accordance with non-limiting aspects of the present invention, the usage of customer digital signature during a transaction in order to give payment instruction to a bank, the method of embedding the security hash value of unique information into the customer digital certificate, the method of using and verifying, but impossibly peeking at, such unique information in a payment transaction, were not heretofore provided in the conventional arts.

The following example of a transaction is made by way of example and not by way of limitation. It is an example of a consumer making an online c-commerce transaction with an online merchant and requesting that payment be made from the customers bank account and be sent or transferred electronically to the merchants account at the same or a different bank. The bank may also verify that the customer has sufficient money or credit to complete the transaction for the agreed amount with the merchant. A recognized certificate authority is involved in that it has previously issued a customer digital certificate and a merchant digital certificate and it maintains a database that at least maintains on a timely basis (e.g., ever 2 hours, 6 hours, daily, or at agreed upon governmental or regulatory body provided time intervals) an indication that the digital certificates of the customer and merchant are active and valid and not revoked, expired, or suspended so that the transaction should not take place.

The transaction may begin by the consumer going to a merchant portal or web site, and the consumer browsing the site and making selections for purchase in conventional manner. The consumer may then select from checkout payment options. When there is an option to pay using the customer smart card, the customer puts his/her smart card in the smart card reader (or reader/writer) waits for it to be recognized by the computer and then types or otherwise inputs his/here PIN number password (PW) or other private identifier. The customer may need to identify his/her member bank via the merchant portal or via redirection or link to the payment portal or bank but more likely the customer banks from which he/she wants to access funds for payment will be identified from the information in the smart card.

If the customer has a valid identity and digital certificate that match and are valid, the bank will continue to move forward with the customer instructions regarding the transaction, otherwise the transaction will stop. If the customer identity and certificate match and are valid, then the bank will also check merchant 502 to verify the merchant has a valid account with the same or a different payment portal or bank and a valid merchant digital certificate. The merchant may have a digital certificate card reader in some instances, but for larger merchant organizations, other means and mechanisms may be implemented to assure that the entity to which the consumer intends to transfer money or have a non-monetary interaction is who that merchant purports to be, so that the merchant's staff can use their organization certificate to reply to the customer, this permits any enquiry/response and the customer is still able to reply by the merchant email even though the customer do not need to register with each merchant.

In some jurisdictions, the merchant must also have a valid business registration, and this may optionally be checked by the payment portal 503. If the merchant identity and digital certificate match and are valid, then the transaction will proceed to the next step.

For any attempted transaction a check or determination will be made by the payment portal or bank 501 that both the customer (buyer or payor) and merchant (seller or payee) digital certificates are valid. The certificate authority is responsible for maintaining the current status of the digital certificates, such as by maintaining a certificate revocation list (CRL) in a LDAP 515 of the database on the certificate authority server 503. If the customer or merchant server digital certificates are not valid then the transaction will not proceed and in fact access to the Transaction/Payment server portal will be denied. It should be noted that the digital certificates themselves are not sent over the internet or network 508, but rather it will go back to the LDAP to check if no valid merchant server certificates are found, and the portal will warn the customer and refuse to send the transaction back for payment processing.

In this closed-loop operating environment where the payment portal or bank 501 cooperates and interacts with the certificate authority 503 to perform mutual matching and authentication of both parties to the transaction, both the consumer and merchant are protected from loss. For example, even if the merchant should shutter their doors and stop operation, the customer will be protected from loss of the funds because of the checking the bank and certificate authority, in the unlikely event that a certificate is revoked shortly before the transaction and not updated in the CRL of the LDAP, the bank may delay actual transfer of funds to the merchant bank for the period of time of the CRL update, as may the merchant delay shipment of the purchased goods until such transaction clears. Optionally, the customer and merchant may be further protected by contract or operation of law from liability or loss when some negligence or fraud occurs.

In another transaction scenario example, the payee might for example, be a utility company that offers its customers (payors) an additional alternative to conventional payment choices in permitting the customer to make payments to it via the Transaction/Payments Server and Portal. In such instance, the utility company would provide billing information to the payments portal (for example, an ID card number as a matching factor or download all the bills or account information with the matched ID numbers) and a customer using his/her digital certificate. It may be noted that in at least some non-limiting embodiments, an applicant (also referred to as the owner or user) for a recognized certificate authority personal digital certificate needs to register with an official ID card and ID card number, then the CA will cryptographically hash the ID number in the certificate, with possibly other information such as the applicant's name, applicant's e-mail address, and/or other information or data. Once the digital certificate with PKCS #12 or PKCS ∩11 and PIN is correct, the cryptographic hash value will convert back to normal reading value and the user would be able to access that payments portal to securely view only his/her billing or account details and provide payment instructions in relation to one or more of such bills or accounts.

In yet another non-limiting example scenario, payors and payees may be issued with digital certificates from multiple different certificate authorities, but all of such certificate authorities should be issued under each individual ID card name holder or company registered name, therefore, it work with the law of each country government regulator owned certificate authority, so it is more trustworthy, than perhaps is a non-governmental (e.g., a non-governmental commercial certificate authority). Advantageously any recognized certificate authorities may have in place a mechanism for the mutual recognition of one another's digital certificates.

In still another non-limiting embodiment, the digital certificates are embedded within mobile communication device, such as for example in the SIM card of a mobile telephone, PDA, or other mobile information appliance, so that such digital certificates can be deployed by payors from their mobile phones, PDAs, mobile information appliances, or the like. In situations where a cell phone, PDA, or other compact or mobile information appliance may be used a PKCS#12 format certificate may be loaded into a SIM card or module using the special card reader/writer described elsewhere herein. This loading may optionally include a conversion to the PKCS#11 format. It may be understood here, that references to PKCS#12, PKCS#11, or other formats are exemplary and that aspects and embodiments of the invention may advantageously use them, it is not limited only to these formats and it may be expected that new and different formats may develop from time to time and may be used.

One or more certificate authorities (CA), which may or may not be coupled with the Internet at the time of a payor transaction, maintains or provides certificate status to a database that includes a CRL server or computer coupled to the database and storing the CRL data. This updated status may occur via a direct connection with the CRL (LDAP) server or via the Internet. The connection may be fixed or intermittent.

In one non-limiting embodiment, the operator of the Transaction payments Server portal is responsible for having correct digital certificates issued to its registered member payors and payees. In one non-limiting embodiment, the payors may to be provided with appropriate hardware to deploy or securely communicate digital certificates or appropriate portions thereof from personal computers, PDAs, mobile telephones, or other information appliances.

In one embodiment, the appropriate hardware to deploy or securely communicate digital certificates may be the special USB coupled reader/writer, that in one non-limiting embodiment is adapted to read and write smart cards and SIM cards. In another non-limiting embodiment, the digital certificates are embedded on mobile device SIM cards so that such certificates can be deployed by payors from their mobile phones, PDAs, and/or other electronic devices or information appliances.

In another aspect, the special USB coupled reader writer device provides an ability to deploy digital certificates stored in a plurality of different file formats, such as in the PKCS#11 and PKCS#12 formats, from one device. It also permits the copying and transfer of sensitive and secure information from one storage media, such as a SIM card to another storage media type, such as a smart card (or between other similar or dissimilar media types, such as between two different SIM cards and two different Smart cards. The architecture and device features is also compatible with other media types known in the art or to be developed with appropriate changes in the physical or mechanical slots and electrical contact locations, as well as appropriate voltage, current, and interface or data interchange protocols.

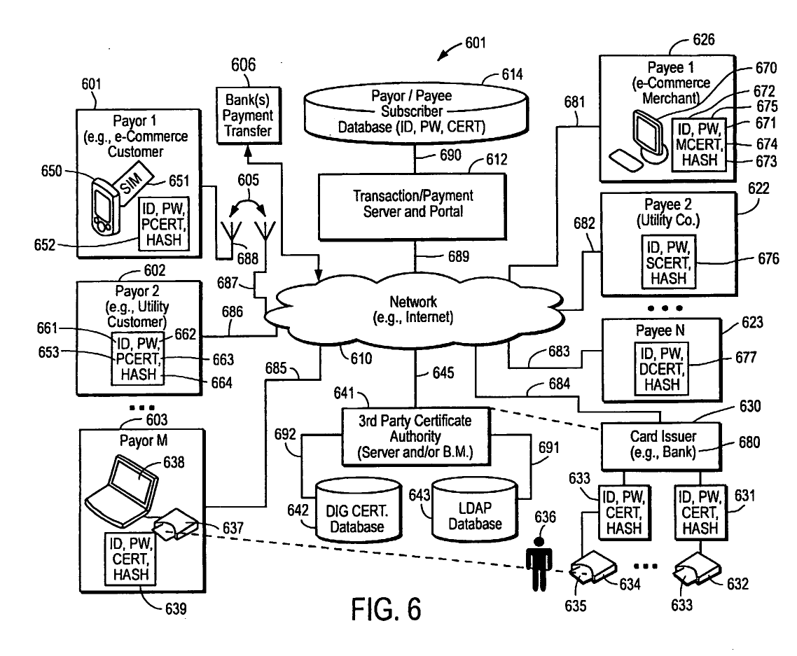

FIG. 6 is an illustration showing a block diagram of an embodiment of a Network 610 coupled system 601 incorporating aspects of the present invention where a payor 601, 602, 603 and the payee have 621, 622, 623 digital certificates (that may be a personal digital certificate 652, a merchant digital certificate 672, an organizational digital certificate 677, and/or a server digital certificate 676), that works within a closed loop authentication system.

The payor and payee work tinder a closed loop and may link up by the Transaction payment server portal 612, the certificate authority 641 (or plural certificate authorities) will have contracts with that Transaction Payment Server Portal 612, and all payors 601 and payees 621 will register with the portal by a valid digital certificate 663, ID number 661, company register number, address information and the like information, so that all members when making buying or selling decision will able to exchange real identity, which can help to cut down fraud. The 3rd party CA 641 may generate and maintain a digital certificate database 642 and a CRL LDAP database 643 which may be a single or two separate databases. A password (PW) 622 and cryptographic hash of the person's or organization's personal or identity information may also be used. The transaction Payment Portal 612 is coupled to a payor and payee subscriber database 614. A card issuer 630 such as a bank 680 may participate by issuing physical smart cards or other tokens 651 onto which digital certificates are loaded using card 635 reader/writer devices 634. This is very different from the ordinary shopping portal and method, and when the portal is support by a highly trusted certificate authority, such as for example a regulated governmental or public certificate body, is may offer government-to-business, government-to-consumer, government-to-business-to-consumer (g2b2c) and/or other transactions.

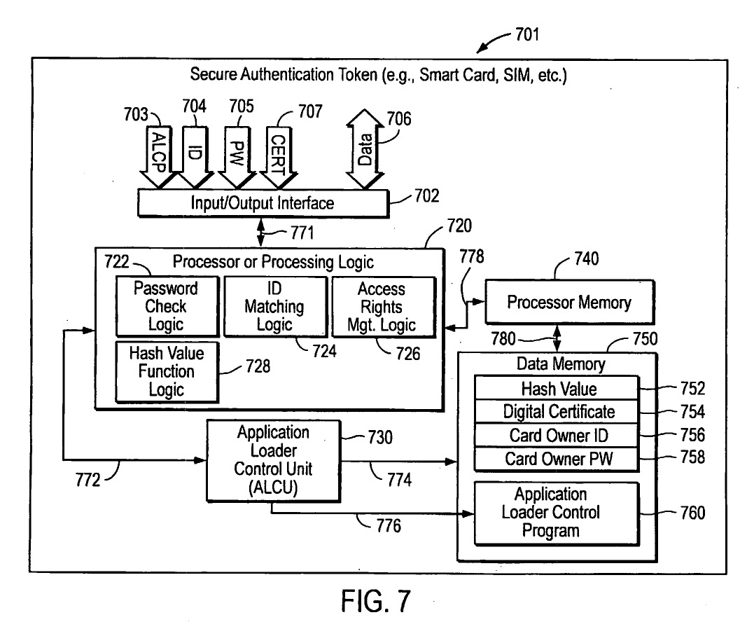

FIG. 7 is an illustration showing an embodiment of a smart card incorporating aspects of the present invention, and configured to ensure the certificate information can properly load and/or open once the card owner or other authorized entity input the correct PIN number or other required access information.

In one non-limiting embodiment, the secure authentication token may be a credit card sized smart card having an integrated circuit that includes a processor or processing logic and a memory embedded therein. In one embodiment, the secure authentication token may be a SIM smart card having an integrated circuit that includes a processor or processing logic and a memory embedded therein.

In one non-limiting embodiment, the secure authentication token as illustrated in FIG. 7 is a smart card 701 that includes a processor or processing logic 720. In one non-limiting embodiment, the processor or processing logic is a special purpose processor or processing logic adapted to accept the loading of a digital certificate loader (application loader) that controls the access to a digital certificate stored within a data memory 750 of the card 701. The certificate loader 730 may also advantageously control, including one of permit, restrict, and prevent the writing of a digital certificate to the card 701. The processor or processing logic 720 may advantageously include password checking logic 722 operative to receive an check a password, ID matching logic 724 adapted to compare ID's and determine if they are matching or non-matching, access rights management logic 726 for managing read and/or write access to the card and data memory 750 within the card, and cryptographic hash value function logic 728 for encrypting and/or decrypting a hash value. The data memory 750 may store a hash value 752, a digital certificate 754, a card owner ID, a card owner PW, and an application loader or certificate loader program code for loading into the processor 720 and the processor coupled memory 740 for execution.

An input/output (I/O) interface is provided between an external environment where it may couple with an external computer, workstation, card reader/writer, or other machine entity. Advantageously, the input/output interface is adapted for coupling with the special smart card reader/writer described herein, such as relative to embodiments in FIGS. 11-16, but other or different devices may be used. The I/O interface may receive a the application loader or certificate loader computer program (ALCP) 703, a card owner ID 704, a card owner password (PW) 705, a digital certificate 706, as well as interchange other data and/or control commands or signals 706.

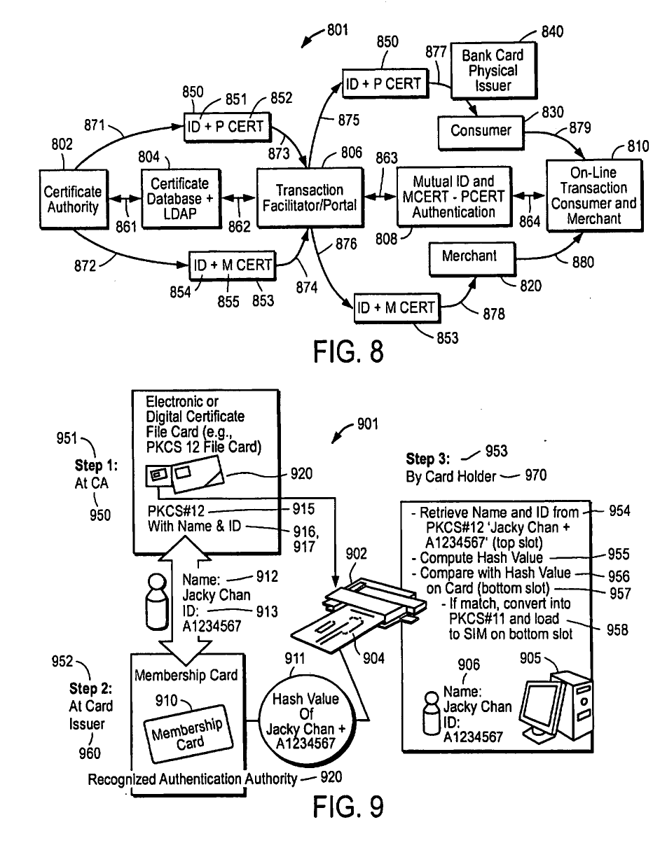

FIG. 8 is an illustration showing the closed loop nature of the method and transaction topology 801 according to an embodiment of the invention where the merchant certificate (or M-cert) 855 may be a server certificate and the Transaction-Facilitator portal 806 may keep all the transactions logs, and/or electronic records as proof of the digitally signed commitment in the event of a dispute or attempted transaction repudiation. This may be a non-limiting example for a customer-to-business (c2b) transaction. When the personal digital certificate (p-cert) 852 is replaced by appropriate merchant cert (m-cert) 855, government certificate (g-cert), business cert (b-cert) or the like then these c2c, c2b, c2g, c2m, g2g, m2m, b2b, and other permutations and combinations are similarly represented.

It may be apparent from this diagram that each attempted communication between the certificate authority 802, transaction-facilitator portal 806, consumer 830, merchant 820 to perform the on-line transaction between the consumer and the merchant 810 is accompanied by an ID and a digital certificate (e.g., 850, 853). The certificate database may include CDL, data and configured as a LDAP 804 is coupled to the certificate authority 802 and either directly or indirectly to the transaction facilitator portal 806. It may be appreciated that references to consumer, merchant, buyer, seller, certificate authority, transaction facilitator portal, and the like may include a reference to the on-line network connection or communication point such as a computer or workstation with which that entity or party connects to the network.

Recall that in one aspect, embodiments of the invention provide a process for implementing secure identification or authentication process by converting a digital certificate issued from a recognized Certification Authority (CA) upon proper authentication of a party or an individual into one or multiple digital certificates. In one non-limiting embodiment, the issued digital certificate may advantageously use a PKCS#12 format, and the converted one or multiple digital certificates issued by the CA may advantageously be in PKCS#11 format, embedded in plastic cards or smart cards having the electronic chip storing and protecting the certificate embedded within the card. These plastic cards may advantageously be plastic cards having an electronic or computer readable storage and possibly processing logic, such as may be found in smart cards having a integrated circuit chip carrying a processing logic coupled to at least one memory.

With reference to FIG. 9, in one non-limiting embodiment of the secure identification or authentication system and process for implementing secure identification 901 may typically include three elements: (1) digital certificate issuance by a recognized Certificate Authority 950 (Step 951), (2) authentication token or card issuance by card issuer 960 (Step 952), and (3) loading Digital Certificate onto the card (Step 953) by card holder 970. Step 953 in one non-limiting embodiment may include retrieving name and ID from the PKCS#12 file 954, on the smart card (step 954), computing the hash value (step 955), comparing with the hash value on the second card such as a smart card on SIM card, and if there is a match then converting it to a PKCS #11 format and loading that into the second card (step 958).

A non-limiting example of a special portable smart card reader/writer that may optionally but advantageously be used with the inventive process or method is also illustrated. The process does not require the use of this particular smart card reader/writer, but has particular advantages when used with it. The particular portable smart card reader/writer that has a slot for a smart card and another slot for a SIM card also significantly extends the range of use and application of the inventive method and processes described herein. Reader/writer devices 902 may be configured to read and/or write to smart cards, SIM cards, and/or other authentication tokens.

The Electronic or Digital Certificate 920 is issued by a recognized CA and may advantageously be in a PKCS#12 format 915 at least because of its standing as a recognized standard. Other formats now know or to be developed may be used or implemented. In some embodiments the Digital Certificate 920 may be in the form of a PKCS#12 File Card as illustrated in FIG. 9 which will include a PKCS#12 file format with name 912, 916 and ID 913, 917. These electronic or digital certificates are referred to as electronic certificates and when stored on a card (such as a smart card) or other card or card-like storage media are referred to as electronic certificate file cards.

The PKCS#12 format is advantageous for these electronic or digital certificates and electronic file cards because it is a simple but personal identification number (PIN) protected flat-file format for storage of the private key. It is good for transport or deployment of digital certificate via different kinds of storage medium or operating systems. Other formats may alternatively be used, including revisions and extensions of this PKCS#12 format, or other formats that may be developed from time to time. After proper authentication of an individual, such as for example by the physical checking of a valid social identity card, national identity card, or the like as compared to the person requesting the certificate that may depend on country, state, political or governmental affiliation, or the like, the Certification Authority (CA) generates a public-private key pair and the physical digital certificate in PKCS#12 format under the individual's name and a unique identification (ID) number. The digital certificate is then stored on an appropriate storage medium such as a SIM card or any other appropriate storage medium while the public certificate will be published to the CA's repository, such as for example, the CA's Lightweight Directory Access Protocol (LDAP) repository.

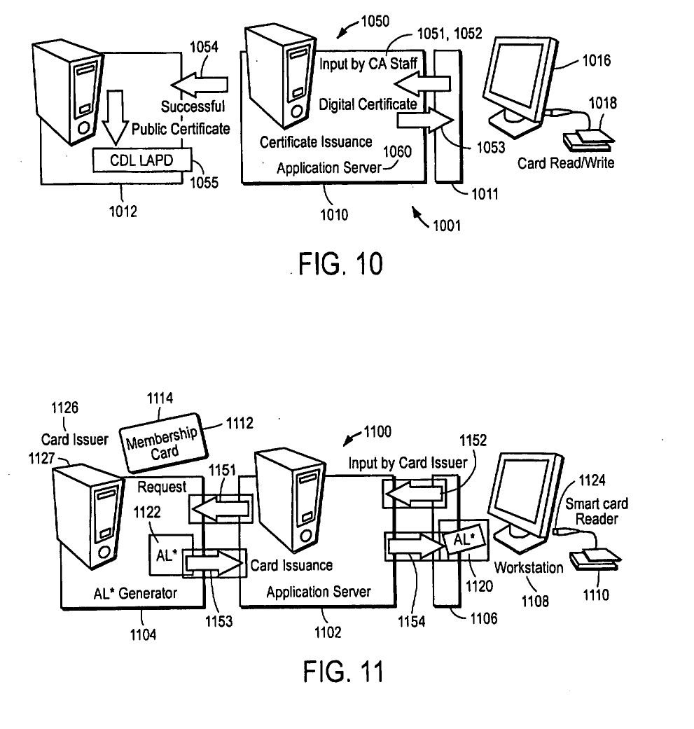

This digital certificate issuance by a recognized certificate authority is further illustrated in FIG. 10. In the exemplary embodiment of FIG. 10, the digital certificate is issued by a recognized certificate authority in a process 1050 and may typically include the following steps:

1. The Certificate authority (CA) staff or other trusted agent opens an interface with a server, such as Internet Explorer (or any other appropriate interface or browser, such as an Apple Macintosh appropriate browser, or a browser adapted and configured for a mobile phone or PDA) and starts the digital certificate issuance application (Step 1051). This application process may alternatively be performed on a local network or local computer, or even on paper, but is not preferred.

2. The CA staff or trusted agent inputs the name and/or identification (ID) number (or any other appropriate identification information of the applicant into system (Step 1052). The identification information of the applicant should be such as to assure that the applicant is who he or she claims to be within some accepted confidence or probability.

3. The certificate authority's system, such as programs executing on the certificate authority's server, then generates the private key and public key pair and also the digital certificate for the applicant (Step 1053). As described elsewhere herein, the digital certificate is advantageously a digital certificate in a standard format or formats, such as in the PKCS#12 and PKCS#11 formats.

4. The digital certificate is then stored by the certificate authority (or a trusted authorized agent thereof into a tangible computer or machine external digital or electronic storage medium, such as for example as a floppy disk, electronic certificate File Card, USB storage module, or other memory device. This storage may advantageously be without leaving any copy of the digital certificate not intended to be public in the system (Step 1054). Embodiments may provide for storage of a copy in the system or a system connected device, but this may be disadvantageous because someone who may access the system later on could possibly get the copy of digital certificate and try to compromise its integrity or security.

5. After successful issuance of the certificate, the corresponding public certificate is published to a certificate repository, such as a Lightweight Directory Access Protocol (LDAP) repository (Step 1055).

A card reader/writer 1018, such as a USB interfaced smart card reader/writer 1018 may be connected to a work station(s) 1610. The input by CA staff, issuance of digital certificate generation of successful public certificate, and publication to a CDC LDAP may be accomplished on or using a certificate issuance application server 1060.

As used here, reference to a card or smart card or SIM is also a reference to other types of authentication token. Card or authentication token issuance, such as a banking card, membership card, or other card issuance, by a card issuer may be by any appropriate organization desiring to issue such cards. A card issuer may for example be a commercial bank or other financial institution issuing a credit card, debit card, asset management card, or the like to an account holder of that bank or financial institution. A card issuer may also be a business, corporation, health care entity, or any other institution that may chose to provide money, goods, or services using the authentication features described herein.

A card issuer needs a secure way to associate the personal identity of the card holder with the physical card or other authentication token. In addition to printing the name and/or photograph of the card holder, the card issuer may further input the name and unique ID of the cardholder into a software or firmware storage or to a computer firmware or software program referred to here as the Card Control Manager or CCM program. The CCM is configured to generate the hash value of the name and ID number of the cardholder, or the hash value of any other identification information or data deemed appropriate to identify the card holder. The hash value is then embedded a memory element, such as on the SIM chip, attached to or embedded within the plastic card (a smart card) and will be sent to the cardholder for activation. In one non-limiting embodiment, the hash value is the hash value of a national identity card number. In one non-limiting embodiment, the national identity card number is a United States national identity card number. In one non-limiting embodiment, the national identity card number is a Hong Kong national identity card number. In one non-limiting embodiment, the hash value is the hash value of a national identity card number is included in the digital certificate. When the hash of the national identity card number is included in the digital certificate stored in the smart card, and the smart card is accessed using the correct password, then when the digital certificate is accessed the hash of the national identity card number will match the hash of the national identity number in the digital certificate will match the real national identity number. This same relationship and matching also applies to other membership, group, or other identity information other than national identity card numbers.

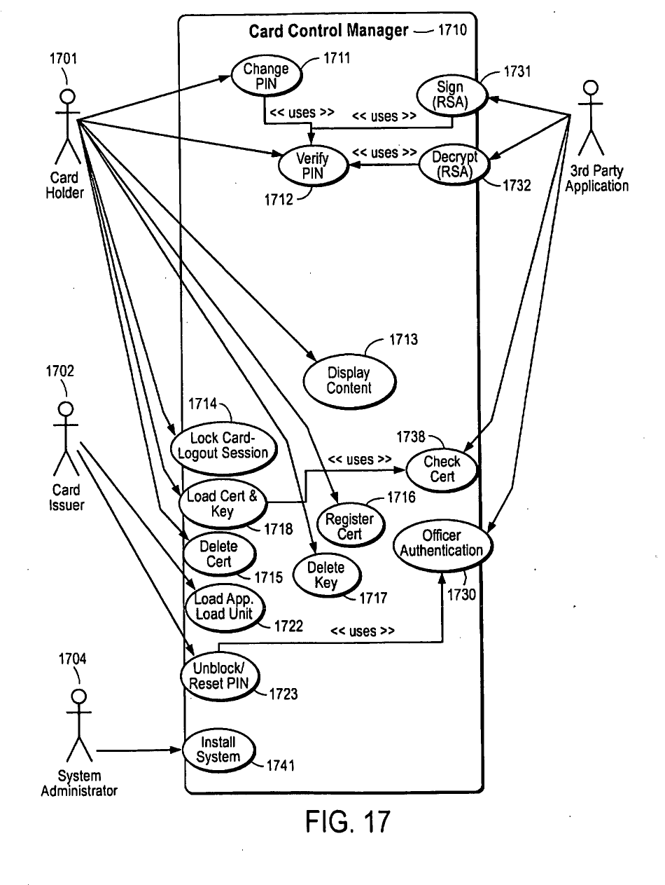

A non-limiting embodiment of an example Card Control Manager (CCM) is described in greater detail elsewhere herein, including in FIG. 17-20.

FIG. 11 is an illustration showing an integrated circuit 1112 containing membership card 1114 (such as a bank card) issuance process according to an embodiment of the invention and the manner in which a unique digital value is loaded onto an authentication token such as a smart card using a special application loader (or digital certificate loader (CL)) to ensure that only the holder of the correct digital certificate can load his/her digital certificate onto that particular token or card.

An exemplary embodiment of membership card issuance process 1100 by a card Issuer is now described relative to FIG. 11. In this exemplary embodiment, the following actions occur:

1. Card Issuer 1126 on a card issuance application server 1102 opens the Internet Explorer (or other appropriate interface or web browser) and starts the card issuance application through a workstation (Step 1151). The workstation may be a personal computer (PC) of any type of computer or information appliance installed with smart card reader/writer.

2. Card Issuer 1126 inputs the name and/or pre-assigned unique ID number of the member to the system (Step 1152).

3. Application server then passes a request 1151 containing the name and/or ID number to a back-end Application Loader (AL) generator 1104 (Step 1151). The Application loader is also sometimes referred to as the application loader and control or the certificate loader or the certificate loader and control because to the part it plays in loading and controlling access to the digital certificate.

4. The Application Loader (AL) generator 1104 then writes a block of proprietary code 1122 (i.e., the application loader or AL code or certificate loader or CL code) for embedding into smart card 1112, 1114. In one non-limiting embodiment the application loader code includes executable code and a security hash value of other card holder specific information or data. In another non-limiting embodiment, the application loader code does not include this security hash value and the security has value is written to the token or smart card at a later time. When the AL code includes a hash value of the name and/or ID number of the member (Step 1154), it is unique and specific to the person to which the card is issued. When the application loader code (or certificate loader code) is written to the card without a particular unique card holder hash value, the particularization to the particular user comes at a later time. For example, the token or smart card may be manufactured in the thousands with the application loader code embedded in the card to thereby permit the card holder specific security information to be written to the card under secure prescribed conditions to uniquely identify the token or card with a particular card holder. Ultimately, the application loader (AL) and the bank or other membership card containing the block of code is unique to the card holder or end user since it contains the unique value of the name or ID or other unique identification.

5. Finally the application loader (AL) or certificate loader (CL) is written to or embedded into the card through the workstation using the authentication token or smart card reader/writer device (Step 1155). As will be described in greater detail herein the application loader (AL) is used to facilitate interoperation of the membership card (such as a bank smart card) to interoperate with aspects of the inventive system.

The application loader (AL) or certificate loader (CL) provides a kind of operating system that permits the interactions between the card control management software executing on the workstation or computer, and the electronic certificate on the SIM card as well as the reading and writing operations with the membership card. It also acts to control read and write access to the card contents so that various rights to write to or alter the contents of the card may be accomplished. These rights may for example, include an ability of an official associated with the card issuer to reset passwords, rewrite a digital certificate or security identification or hash information to the card. The application loader software or firmware executing in the processor of the smart card may also permit the end user to write to the card in a manner that has not heretofore been possible with conventional smart cards or other authentication tokens.

To activate the new card with his/her personal identification information, the card holder can insert the memory or SIM chip containing the card holder's digital certificate from the CA (such as the illustrated electronic certificate File Card having a PKCS#12 format) and the new membership card into a reader/writer device, such as for example into a specialized hardware device 600 (described in greater detail herein) adapted for reading from and writing to the SIM card and the smart membership card. The Card Control Manager software executing in the workstation may be invoked to retrieve the name and unique ID from the digital certificate stored securely in the SIM card and compute the corresponding hash value. The computed hash value will then be compared with the stored hash value on the membership card, and if they match, the cardholder's digital certificate, such as for example a certificate in PKCS#12 format, will be loaded onto the membership card. When using the certificate in PKCS#12 format, the certificate loaded into the card may be in PKCS#11 format which is preferred for smart cards. This process of reading the electronic certificate file from the SIM card, comparing the hash values, converting the PKCS#12 format to the PKCS#11 format when the hash values match, and then writing the PKCS#11 format certificate to the smart membership card may be repeated for multiple membership cards, and thus an individual may personalize many cards for different commercial and/or personal applications.

Aspects of a non-limiting example of the application loader (AL) referred to above are now described in further detail.

It may be appreciated that a smart card has an integrated circuit chip that includes an electronic processor or some processing logic that may typically be a combination of hardware electronic circuits (including memory circuits) that permit software or firmware executing in the processor or processing logic to operate in a particular manner to achieve a particular result. When the semiconductor integrated circuit chip is fabricated it does not usually include any firmware or software. The processor or processing logic and the memory used for storing data and instructions may also be specific to particular software or firmware to be executed therein. It may for example be advantageous to provide a particular memory size or configuration that are optimized to the processing tasks to be completed, to provide circuit structure and operation that minimize electrical power or energy needed to operate the smart card based processor and to maintain the memory contents. Security is also a concern as the security features associated with the card, such as a user identify, access password, and other personal information need to be protected from compromise. Of course if the smart card also stores a security digital certificate, then that must also be protected from unauthorized access or compromise. Usually, costs are also a concern because the cards are usually issued without cost to a card holder, customer, or other end user.

A smart card of whatever media type according to example embodiments of the present invention therefore has a particular processor and memory architecture and is designed and fabricated so as to support the features described. The structure of the inventive smart card processor is adapted to receive, store, and execute the application loader program code and acts to direct its operations and to control read and write access of data stored in the card. This may include the card holder or customer end user identity and/or other personal information, as well as security cryptographic hash values of some or all of the stored data or information.

As is known in the art cryptographic hash function is a deterministic procedure that takes a selected or arbitrary block of data or information and returns a fixed-size or variable-size set of bit or bytes, which is referred to as the has of that block or its hash value. The hash function is designed so that an accidental or intentional change to the data will almost certainly change the hash value. An ideal hash function has four main properties: (1) it is easy to compute the hash for any given data, (2) it is extremely difficult to construct a text or symbol sequence that has a particular given hash, (3) it is extremely difficult to modify a given text or symbol sequence without changing its hash value, and (4) it is extremely unlikely that two different blocks will have the same hash value.

The application loader is loaded into the smart card either at or just after the time of manufacture of the card, or at any time before the card is issued to the particular customer or end user. The end user personal data is loaded or embedded into the smart card after the application loader is loaded and controls this loading and writing of the end user information. It may also control read and write access to the smart card so that additional or other information may be written to the card, such as for example a card issuing authority identity, account or membership information, and/or other data or information that may be relevant to card ownership, identity, use rights, and the like.

It may be appreciate that the application loader or loader controller acts to enable what would otherwise be a dumb processor incapable of any activity except perhaps receiving the application loader program code itself, with a set of instructions, so that the smart card can perform the set of prescribed operations. It may be considered to act as either an operating system for the smart card processing logic and memory operations or as an applications program. Once the application loader (AL) is in the card, it may be instructed to perform other operations, such as for example to load a specific digital certificate (or even multiple digital certificates for the same user), to load or reset a password stored in the card, or other operations. The application loader may also be operative to provide different access levels, different read capabilities, different write capabilities, and so forth to different persons or entities and under different security measures.

The application loader control provides at least two functions or operations. First, it operates to insure the security of the card by controlling who can read from and write to the card. It may usually provide different read access levels or capabilities to different entities and may similarly provide different write access levels or capabilities to different entities. The different entities may have different identities and/or passwords for their accesses. Different external application software may also be needed to provide certain read or write operations with the card. For example, an end user of the card may be able to perform certain read or write operations with their unique user identity and password, and an issuing bank may be provided with other read and write access rights using their identification and password either with the same software or with different software than the end user may have available to him/her.

The application loader control also provides an important identify matching operation before any write to card operation is permitted. More specifically, the identity of the person who desires to perform a write operation to the card must match the identity of the person who owns the digital certificate on the card.

A digital certificate may also be loaded onto the smart card under the control of the application loader. Furthermore, embodiments of the invention may permit multiple digital certificates to be written to a single smart card. At least some embodiments, permit the end user or consumer to write or rewrite data or information to the smart card using the application loader. In some embodiments, the application loader program will execute within an application loader unit or process within the processing logic of the smart card, and may usually cooperate with an external entity such as a second or companion program to the application loader and/or with a card control manager (CCM) executing on a separate external computing machine or information appliance. An end user may use a different program executing on an external computer or information appliance from the program used by the card issuer, or different read and or write rights may be provided to card holder and card issuer so that different rights for managing and changing information and data will apply to the end user and card issuer.

As described above, the smart card has a unique numerical value or set of symbols that are inserted or embedded into each card prevent someone other than the legal owner of the card from loading a digital certificate onto somebody else's card.

While there may be many reasons why an end user may need or want to write to his/her smart card, one reason is that some digital certificates will have an expiration date and in order for the card to remain usable, the digital certificate needs to be reloaded after it is replaced or renewed by the certificate authority. For example, certain government issued digital certificates may have a 6-month, 1-year, 2-year, or other period of validity and then need to be reissued. This may be to provide an additional level of security that an earlier issued certificate has not fallen into another parties hands and might be unlawfully used. These digital certificates may also expire by operation of law or local ordinance. The ability of the individual end user to load or reload their digital certificate onto an existing smart card provides convenience, lower cost than replacing the card, positive environmental effects because the card lifetime is extended and may be used either by the original end user to whom the card was issued, or after erasing the original digital certificate and setting a different password and identity by a new end user.

The application loader also allows access to the card alter identity is verified so that one can write to the card to reset the password so the card begins to be usable again under the new password. Of course there is a requirement that one has to verify that the identify ID card number is equal to or matches the ID card number that is assigned to the digital certificate. In practice, this match may be between the cryptographic hash value of the identification number or symbol sequence or ID card number. In one example, the hash value is contained in the digital certificate and when the smart card is opened using a top level password access, a determination is made as to whether the identification presented matches the identification stored in the digital certificate with which the digital certificate matched to it what it was created.

In use, the end user or consumer presents or connects the smart card using a smart card reader device, a password is entered, identity is checked and matched with that embedded in the digital certificate, and then the transaction may be completed. Here the digital certificate acts in the same manner as a handwritten signature may act to form a legally binding agreement for conventional contracts, face-to-face credit/debit card transactions, and the like.

The features of the inventive smart card and the method of its use in conducting a transaction provide a closed loop with significant security safeguards to verify identity, provide authentication, nonrepudiation of the transaction, and a digital certificate based electronic signature. Non-limiting embodiments also provide an electronic copy or the transaction, such as in the form of an electronic sales slip, money transfer, or the like. Alternatively or in addition, an electronic log of the transaction may be maintained and sent to the parties involved in the transaction, and advantageously or by requirement to the payment or transaction portal.

A digital certificate is issued a certificate authority, the end user identity is the citizen personal identity number, and the hash value is a cryptographic hash value of a citizen personal ID number.

In one non-limiting embodiment, the digital certificate may include at least the following features: (a) it is issued by a certification authority for the purpose of supporting a digital signature which purports to confirm identity or other significant characteristics of the person who holds a particular key pair; (b) identifies the certification authority issuing it; (c) names or identifies the person to whom it is issued; (d) contains the public key of the person to whom it is issued; and (e) is signed by a responsible officer of the certification issuing it.

In one non-limiting embodiment, the hash function includes an algorithm mapping or transforming one sequence of bits into another, generally smaller, set as the hash result or hash value so that (a) a record yields the same hash result or hash value every time the algorithm is executed using the same record as input; (b) it is computationally not feasible for a record to be derived or reconstituted from the hash result or hash value produced by the algorithm; and (c) it is computationally not feasible that two records can be found to produce the same hash result or hash value using the algorithm.

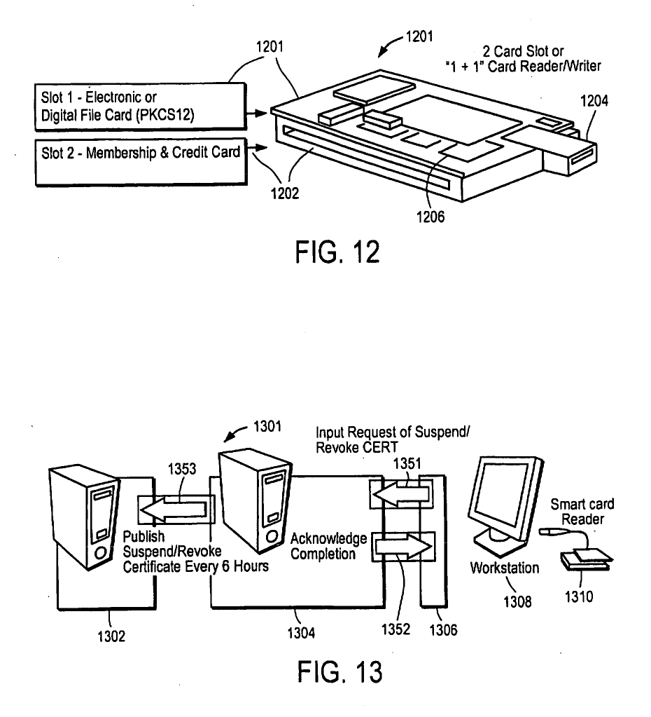

FIG. 12 is an illustration showing a example of a card reader/writer 1201 having dual-card slots 1201, 1202 and associated electronic interfaces for receiving a electronic or digital file card and a smart card type authentication token such as a membership card, credit card, or the according to an embodiment of the invention. This dual-card slot USB port 1204 coupleable reader/writer may advantageously be used on conjunction with a process for embedding a digital certificate onto a membership card, credit card, debit card, or other financial institution type smart card. A printed circuit card 1206 carries the electronics and card contacts. In this embedding process, the following steps are carried out:

1. A specialized USB device with built-in memory is designed to make copying digital certificate onto card easy and secure. The USB interface 1204 provides a convenient and now almost universal connectivity to a computer, workstation, or other information appliance that can execute software for interacting with the USB reader/writer device and therefore with electronic certificate carrying SIM card (or other storage media) and the membership smart card. More built-in memory permits greater certificate storage and in one embodiment 512 KB of memory provides for storage of about 30 certificates, more of less memory may be provided (Step 401).

2. First slot 1201 can accept the SIM module of an electronic certificate File Card, which contains the digital certificate (advantageously in PKCS#12 format).

3. Second Slot 1202 can accept the membership smart card into which the Application Loader (AL) is already embedded by the card issuer. Recall that the AL is unique to each cardholder. In one embodiment the USB reader/writer device is adapted to receive the smart membership card by inserting the short edge of the card into the second slot so that the card reader/writer device can be very small and pocket size, in at least one embodiment, only slightly larger than a large USB thumb drive (See for example FIG. 15).

4. Software running on a workstation will recognize the USB device when it is plugged into the workstation and that software will retrieve the name and/or ID number from digital certificate file and compute the hash value.

5. The software will also compare or cause a comparison between the computed hash value of the electronic certificate on the SIM and the hash value stored on the membership card. They should match. If they do not match, the digital certificate from the SIM card cannot be embedded onto the membership smart card. If they match, then the digital certificate can be embedded or stored into the card after a conversion from the PKCS#12 format appropriate to the SIM card storage to the PKCS#11 format appropriate to the Membership smart card storage (Step 405).

6. This process can also be repeated for multiple cards, and thus an individual can personalize many cards for different commercial applications.

This process for writing one or more certificates to membership smart cards is not simply a copying operation. Although the Card Control Manager or CCM software program executing within the workstation or computer is operative to interact with the card reader/writer device and with the electronic certificate containing SIM card and the membership smart card to which it is desired to embed an equivalent PKCS#11 certificate, in a preferred embodiment of the invention, the certificates are never written to any memory of the workstation or computer. Only the hash value of the SIM card electronic certificate and the hash value stored in the membership smart card are brought into the workstation computer for the purpose of logical or numerical comparison in the manner that hash values are normally compared. The device reader/writer has its own internal memory, such as a flash memory, for storing the certificate during a copying and/or format conversion operation. In one embodiment, the internal memory is provided within a microcontroller unit (MCU) so that a separate memory device or chip is not required. One or more microcontrollers within the reader/writer device are operative to perform the reading, format conversion, and writing operations.

In other embodiments, the workstation or computer may provide for intermediate storage of one or more of the PKCS#12 or PKCS#11 format certificates, but this is disadvantageous as it provides a potential security weak point where a virus, Trojan Horse, spy-ware, hacker code, or other malicious code may cause a compromise of the certificate and/or other security features.

It may also be appreciated from the above description that the invention also includes a smart card, such as a membership smart card having an embedded integrated circuit that carries the Application Loader (AL) which is required for the desired interaction between the Card Control Manager or CCM software program executing in the workstation computer and the membership card. A conventional smart card does not have this AL and therefore will not be capable of interacting with the Card Control Manager software/firmware program.

It should also be appreciated that the inventive read/writer device is more than a USB device that provides for reading from or writing to two different memory devices, such as to/from a SIM card and to/from a smart card or other authentication token having processor and storage. One difference is the ability to write from the SIM or other memory to the internal reader/writer device memory, and then to write from the internal reader/writer device memory directly to the smart card or other authentication token memory without needing to expose those contents to the computer, information appliance, or workstation memory or storage. The reader/writer device may be owned by the person or user for authenticating his/her own cards so as to further reduce the risk of compromise.

The synergistic combination of the Card Control Management software and its executable instructions, the USB-interface (or other interface) based dual-media reader/writer (e.g., SIM card and Smart Card media), and the embedding of the membership smart card (or other media card) with the application loader (AL), provides an operating system and environment with novel and unique features and capabilities.

A digital certificate may also be suspended or revoked by a recognized certificate authority (CA) and may include a procedure illustrated 1301 in FIG. 13 and including the following steps.

1. CA staff opens the Internet Explorer (or other interface or internet or network browser) and starts the digital certificate suspend/revoke application (Step 1351).

2. CA staff inputs the name and/or ID number of the applicant in order to search the digital certificate and searching for the digital certificate (Step 1352) CA staff verifies that the digital certificate identified in the search is the digital certificate associated with the applicant for revocation or suspension and CA staff issuing a command that the digital certificate is to be suspended or to be revoked .

3. CA staff will receive immediate response of completion from the system (Step 1355) that the identified digital certificate has been suspended or revoked.

In connection with this process it may be noted that in certain jurisdictions, suspended or revoked certificate are published to Certificate Revocation List (CRL) periodically. For example, a recognized CA could be published every 6 hours, daily, or at some other predetermined interval. Such periodic updated provide for fast and efficient suspension and revocation and recognition by others of such suspension or revocation.

PKCS#12 is a known Personal Information Exchange Syntax and is one of the family of standards called Public-Key Cryptography Standards (PKCS), published by RSA Laboratories, incorporated by reference, and not described further here.

PKCS#11 in cryptography, is one of the family of standards called Public-Key Cryptography Standards (PKCS), published by RSA Laboratories, incorporated by reference, and not further described here. It defines a platform-independent Application Program Interface (API) to cryptographic tokens, such as Hardware Security Modules and smart cards. This API has been developed to be an abstraction layer for the generic cryptographic token. The PKCS#11 API defines most commonly used cryptographic object types (RSA keys, X.509 Certificates, DES/Triple DES keys, etc.) and all the functions needed to use, create/generate, modify and delete those objects. PKCS#11 is largely adopted to access smart cards. Most commercial Certification Authority software uses PKCS#11 to access the CA signing key or to enroll user certificates. For this reason, PKCS#11 is one of the standards that may be used with the system and method described here.

Among the features and advantages of at least some of the embodiments, there includes the advantageous use of the PKCS#11 format for security and portability. PKCS#11 is the format to preferably be embedded on the inventive cards. PKCS#11 represents the cryptographic token interface standard, which specifies an Application Programming Interface (API) between applications and different types of hardware devices (or cryptographic tokens), thus enabling resource sharing (among different applications) and portability of application across different hardware.

Another advantageous feature is the provision of a specialized hardware device for easy electronic or digital certificate management. In accordance with one non-limiting embodiment, this specialized hardware device includes a universal serial bus (USB) interface device that includes enough built-in memory to store multiple digital certificates. In one particular embodiment, the device includes 512 KB of built in memory, sufficient memory to store up approximately 30 digital certificates. The interface and built in memory are each designed to make managing digital certificates and copying onto cards easy.

A further advantageous feature is the ability to authenticate the existence and/or legal capacity of an individual under jurisdiction only once, and apply this validation process virtually via the digital certificate in multiple applications. Certificate Authority, which are usually regulated, highly trustworthy organizations, will perform the role of authentication. Multiple commercial applications can then leverage upon the result of the single authentication process without the need of repeating the effort or keeping individual's private data.

These and other innovations are not provided by the conventional arts. For example, the conventional arts may provide for embedded SIM chips on plastic credit cards that are used for payment applications. Aspects of the invention are differentiated at least because they integrate Public Key Infrastructure (PKI) technologies, and by integrating PKI technologies into widely circulated medium such as smart credit cards, the latter can also serve as security devices for enabling digital signature, encrypting data for transmission over wireless network, and other applications.

As a further example, conventional common credit cards or membership cards have ‘weak’ authentication, such as in the form of a printed name and photo. Embodiments of the invention provide a strong authentication. Proper authentication will be carried out by regulated agencies such as a government-recognized CA. Once authenticated, the personal identification information can be replicated in a secure and controlled manner on multiple cards serving different applications. The combination of these features with existing PKI infrastructure also ensures the continued monitoring and validity of the information, such as for example where applications can regularly check the CA's Certificate Revocation List (CRL) to see if a digital certificate has been revoked, and take appropriate action in such instances.

As yet a further example, in conventional systems and methods, individuals need to register his/her private information with the issuer, which will then print the information on the cards issued. By comparison, embodiments of the invention provide for cardholders to have complete control over implanting his/her unique digital certificate on as many cards or applications as desired by acquiring the specialized hardware device and accompanying software, which are economically affordable.

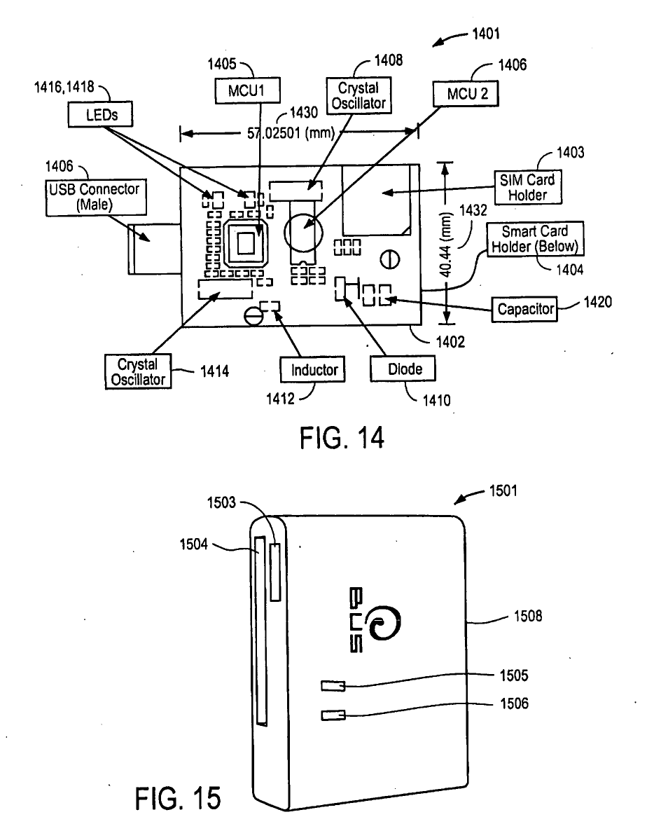

FIG. 14 is an illustration of an embodiment of the structure 1401 of the specialized USB interfaced 1406 hardware reader/writer device for interacting concurrently or separately with a SIM card and a membership smart card. The board 1402 shown in FIG. 14 is adapted for interfacing with the plastic substrate type smart card on the opposite side (not shown) of the PC board and coupled to it via standard wires, bus, flexible PC board, contact pins or pads or other connection means known in the art. A SIM card slot or holder 1403 is provided as the top surface of the board. Although the illustrated embodiment includes two Micro-Controller Units (MCU) 405, 1406, this is for reasons of implementation convenience in that the implementation was simpler using two MCUs rather that a single MCU. In at least one embodiment the MCU or MCUs are responsible for providing communications, such as over the USB interface, and in one embodiment for providing a USB hub for connecting and enabling communication between and among the external workstation that may be connected thereto and the SIM card (or other first media type) in the SIM card slot 1403 and the smart card (or other second media type) in the smart card slot. The MCU or MCUs may also provide the internal memory used when copying and/or converting the digital certificates between media.

The first crystal oscillator 1408 and second crystal oscillator 1414 are provided to generate timing signals and the capacitors 1420 and inductors 1412 are provide to meet the needs of the other circuit elements as known in the art. LEDs 1416, 1418 may be provided to indicate one or more status of the device such as read operations, write operations, or other status that may be desired. The USB connector 1406 is provided for interfacing the hardware device to another device such as to a personal computer for the exchange of data, commands, or other information. SIM Card Holder 1403 is responsible for holding and providing an electrical interface to the SIM card. A membership card interface and slot 1404 is stacked onto this card 1402 or otherwise provided and is responsible for accepting a membership card and for providing an interface, such as via electronic contacts or non-contact means for communicating between the chip on the smart card and the special device.

It may be appreciated by workers having ordinary skill in the art that although great emphasis has been placed on the USB interface of the dual-card or dual-media reader/writer device, the invention is not limited only to a USB interface or to SIM type media cards or credit card type smart cards. These are the elements that presently provide the best and most universal applicability. As different interfaces may become available and may replace the USB interface as a standard, such interface may be adapted to support the features of one or more of the embodiments described herein. Furthermore, as media types change or evolve or standards for e-commerce or credit/debit transactions evolve or involve different types of tokens, embodiments of the invention may be applied to such media types and tokens. Furthermore, the smart card is an example of a type of physical authentication token or device and the other embodiments may provide for alternative physical forms or carriers for the embedded smart card chip that includes the processor or processing logic and storage described herein.

FIG. 15 is an illustration of the external appearance of the special reader 1501 and shows a first small slot 1503 for inserting a SIM card and a second larger slot 1504 for inserting a credit card sized smart card. A circuit board 1402 included in the housing 1502 is shown and described in FIG. 14. There is also a USB connection port 1508, 1406 (for connecting a USB cable to it and to another device, such as a personal computer or workstation. LEDS 1505, 1506 may indicate device status as described for FIG. 14. It may be noted that this embodiment is made as a very small compact and pocketable device, with some versions being smaller than about 2.5 inches wide by 1.25 inches deep, by less than 0.5 inches thick. The device electronics may be powered by the USB bus and may not require additional power. Embodiments of the device having a small size and weight are advantageous as they are more portable.

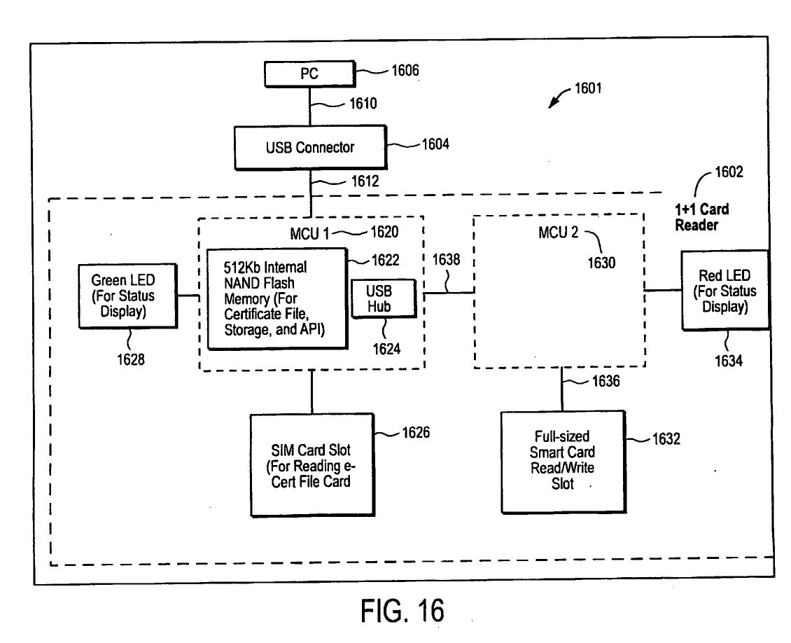

FIG. 16 is an illustration showing a block diagram of a multiple card reader 1601 having two card insertion slots 1626, 1632 and contacts for communicating with the cards or other storage media types. This special card reader is also sometimes referred to as the 1+1 card reader or the “double decker” device because of the way the two cards may be stacked or otherwise inserted concurrently. This is a block diagram of the device of FIG. 12 and FIG. 14. The provision of the two (or more) slots and the electronic connection of both or all cards or media types concurrently permits read and write operations between the electronic circuits in the reader/writer device and the two cards simultaneously. In one aspect, this permits certain operations to be performed that would not be possible with separate sequential read/write operations on different media types. A similar device with more than two card slots for reading and writing to multiple alternative media may be provided in the same manner so that the reader/writer may have any plurality of slots and interfaces. The stacked or double decker nature of the exemplary embodiment is also evident from FIG. 12 and FIG. 15 which shows a corresponding physical device.

The exemplary card device has card read and write capabilities, though with respect to some functions or operations, and some cards, the device may ultimately only be required to perform read operations. In one non-limiting embodiment, the device has a USB interface to an external device, but other alternative interfaces may be provided and even multiple interfaces may be provided to permit communication to different external devices using different interfaces and/or protocols. In one non-limiting embodiment, it can read/write large Smart Card (for example, the PKCS#11 format) and read small electronic certificate file card (for example, the PKCS#12 format). In one non-limiting embodiment, an internal 512 Kbyte memory provides the storage for the electronic certificate files. Different amounts of memory may be provided but the memory should typically be sufficient to store at least one electronic or digital certificate file.

Advantageously, the device permits an end user to perform write operations to the card or other media type. The application loader present in a smart card according to embodiments of the invention and described elsewhere herein permits such card write operations that were not available to any party other than the card issuer heretofore. In one non-limiting example, the reader/writer device illustrated in FIG. 14-FIG. 16 enables digital certificates stored in the at least the two common digital certificate formats of PKCS#11 and PKCS#12 to be deployed from the same device. The device may alternatively be used to deploy other multiple different formatted certificates that exist now or that may be provided in the future.

In one non-limiting embodiment, the card reader/writer has two slots on its side. The smaller slot is the electronic or digital certificate file reader, which has a self-run program that can load the electronic certificate file (for example, an electronic certificate in the PKCS#12 format) from the electronic certificate File Card and store it in the internal memory of the device. The large slot is a Smart Card reader/writer that enables a user to use the electronic or digital certificate (for example, an electronic or digital certificate in the PKCS#11 format) directly from, or load the electronic certificate (PKCS#12) in to your membership card (smart card).

An exemplary architecture is now described with reference to FIG. 16. A first Micro-Controller Unit (MCU 1) 1620 is used for importing PKCS# 12 file from electronic certificate file card, and for providing 512 KB flash memory for storing electronic certificate files. The second Micro-Controller (MCU 2) 1630 is responsible for reading/writing membership card (smart card) (ISO 7816 PC/SC reader). The functions of these two MCUs may be combined into a single MCU having all of their respective features, but in this practical embodiment, the implementation was simpler using more readily available components. A first Crystal Oscillator is responsible for giving a clock to MCU1. A second Crystal Oscillator is responsible for giving a clock to MCU2. The LEDs 1628, 1632 are used to indicate the status of the card readers. Green LED 1628 shows the power status of the electronic certificate card reader. When the green LED is flashing, it means the drive is loading the electronic certificate File. The red LED 1634 shows the status of the Smart Card reader. When it is flashing, it means that the Smart Card reader is loading.

The USB and interface 1604 connector is provided for interfacing the hardware device to another device such as to a personal computer 1606. As shown in the block diagram, there is a USB hub 1624 in the MCU 1 1620 which allows the MCU 2's 1630 USB port 1638 to connect to this USB hub 1624 to interface with the PC 1606. The USB port 1612 of the MCU 1 may be directly connected to the PC or workstation 1606 that executed a card control management program as already described.

The MCU 1 has a GPIO (General Purpose Input Output) port connect to the SIM card holder 1626. The communication between the MCU 1 and the electronic certificate File card (PKCS#12) may be by serial communication. Similarly, the MCU 2 provides a GPIO port connect to the Smart Card slot 1632. The communication between the MCU 2 and the membership card (PKCS#11) may also be by serial communication. The software is preloaded in the 512 Kbyte memory in the MCU 1. The software is used to import electronic certificate file to electronic certificate file reader. Note that the MCU 1 is a driverless USB device with 512 Kbyte memory which stored the software for electronic certificate File (PKCS#12) management. The MCU 2 is needed to install the driver to enable the communication interface between PC and Smart Card reader for Smart Cards (PKCS#11 and PKCS#12).

With reference to FIG. 17, attention is now directed to the description of aspects of a card control manager (CCM) and the associated method and process steps under which the cardholder 1701, card issuer 1702, third party and its third party application 1703, and possible system administrator 1704 interact according to an example, and the manner in which the inventive card control manager process facilitates these processes and interactions. It will be apparent that this is merely an exemplary embodiment and that other or different processes, relationships, and interactions may be implemented in accordance with the invention.

In this non-limiting exemplary process model, each or any of a cardholder 1701, a card issuer 1702, a third party and third party application 1703, and/or a system administrator 1704, may interact with or through a Card Control Manager (CCM) 1710.

Card Control Manager (CCM) 1710 is a computer implemented application program having a plurality of executable instructions for execution in a processor coupled to memory in a computer or other information appliance having processing logic, the CCM 1710 has overall responsibility for facilitating the deployment of digital certificates, such as onto personal computers or other information appliances.

Card holder 1701 may interact, upon the receipt of an input from the card holder, with the CCM 1701 to for example, change personal identification number (PIN) 1711, verify PIN 1712, display content of digital certificate 1713, Lock card—Logout session 1714, delete a certificate stored on the cardholder's card 1715, register a certificate 1716, delete a key 1717, (load certificate and key 1718 and/or perform other functions or activities as may be desired and permitted.

The card issuer, such as for example a banking, financial, or credit institution, may load or embed (Load) an application loader (or certificate loader CL) 1722 to the card, or unblock a card that has been blocked or reset a PIN 1723. Some activities such as the unblocking of the card or resetting of the PIN 1723 may preferably require authentication by another official with higher authority 1730 (e.g., Officer Authentication) than for example and administrative personal in conjunction with the third party application. For example, when unblocking a card or resetting a PIN for card, another official with higher authority (which could be a supervisor of the card issuer) must invoke this officer authentication function to authorize the process. While these operations refer to a card, such as a smart card, the same or analogous procedures may be applied to other authentication tokens other than smart card authentication tokens.

The third party application can make use of a certain application program interface (API) to interact with certain functions of the CCM 1710 including electronically sign 1738 and decrypt 1732 any hash value 1733 with the private key stored on the card. The CCM junction may be used as the third party applicant to check the certificate 1738. An RSA scheme may advantageously be used. It is useful to prevent the private key from leaving the card. In particular, when unblocking or resetting a card, another official with higher authority should advantageously invoke an officer authentication function 1730 to authorize the process. In some non-limiting examples, the higher authority or officer authentication may be required.

A system administrator 1704 may perform various administrative functions, even including for example installing a system 1741 and updating it.

The process can be described from two alternative perspectives in terms of the following models. From a first perspective or model, there is a user interaction model which explains the manner in which the end users interact with the system in order to conduct a task. The end users may for example include the cardholder and the card issuer. From a second perspective or model, there is a system architectural model that describes the system and processes that are required for the operation of the system. In other words this perspective may include the card, certificate, application loader, and software issuance operations.

Attention is first directed to a description of a non-limiting exemplary embodiment of a user interaction process associated with a card issuer and/or a cardholder when using a digital certificate (DC). In at least one embodiment, this interaction process or method may be a computer implemented process as computer program using computer program software and/or firmware having a plurality of executable computer program instructions. At least some example processes also involve the interaction with and cooperation with external hardware such as various memory cards or devices that may also include specialized processors such as controllers for facilitating the secure copying and/or conversion operations between different objects or media types. Embodiments of the inventive processes and methods are advantageously protected by the user Personal Identification Number (PIN) or other security features.

Embodiments of the invention include the computer or information appliance implemented method and the computer program product stored on a tangible computer readable media. In one non-limiting embodiment, this method and software or firmware are referred to as the Card Control Manager (CCM) method and software. The Card Control Manager (CCM) software and method may be used to manage settings and parameters associated with the inventive system and method, such as for example smart card readers, keys, certificates, and applications.

For the convenience of the reader the description is broken down into four sections as follows, each of which will be described separately so that overall system, method, card control manager structure and method, and computer program software and/or firmware may be better understood. The four sections are identified for convenience and by example as follows, but are not to be interpreted as limiting the scope of the invention: (a) user interactions with the CCM while using client applications (e.g., secure email) for cryptographic functions, (b) user interactions with the CCM for settings management, (c) user interactions with the CCM for keys and certificate management, and (d) user interaction with the CCM for card unblocking and loading the application loader (AL) onto card.

Attention is first directed to a description of user interactions with this CCM software while using client applications (such as for example, secure email, an access to a server, or other secure electronic communications or transactions between two or more parties) for or involving cryptographic functions. Any operation performed by the user with a client application (e.g. secure email, server interaction, or transaction client software) that requires access to any protected resource will result in a Personal Identification Number (PIN) prompt.

An exemplary interaction with the Card Management System to manage settings is now described. The Card Management functionality may advantageously be split into unprotected resources and protected resources modes or processes.

Management of a smart card reader/writer connected to the computer, information appliance, or workstation may usually occur in an unprotected mode, and when operating in unprotected mode does not require entry of PIN for verification. Management of smart card readers may for example include changing smart card reader properties and setting up new card readers. These unprotected processes or modes may not usually involve handling or processing any secure data or information, such as any certificates, hashes, PIN, or other secure or sensitive information or data.

Settings for the personal computer, information appliance, workstation or other utility may also typically be unprotected and allow the user to change the behaviour or configuration of the card control manager. These changeable card control manager settings, may for example be to: (a) load a Card Control Manager automatically at operating system (OS) start-up, (b) automatically register certificates with Microsoft Windows certificate store (or other certificate store) when a smart card is inserted, (c) warn the user when a digital certificate is about to expire, (d) change the PIN locking period, and/or (e) any combination of these or other settings or parameters.

The function of viewing digital certificate and smartcards may also be unprotected. Information viewable for cards includes the digital certificate state such as Locked, Unlocked, Blocked, or Permanently Blocked. It should not usually permit viewing the secure contents of the digital certificates or smartcards themselves.

The above described unprotected resources may optionally be treated as protected resources, and in such situations or configurations there may be no unprotected resources or modes and all or a larger set of resources may be treated as protected. Functionality related to managing any smart cards or other authentication tokens inserted in the readers and their contents may normally be protected to allow users access only once the digital certificate(s) have been unlocked. In at least one non-limiting embodiment, the protected functions, resources, or modes may include the following:

(a) Manage smart card properties and their PIN policies;

(b) View and manage existing certificates;

(c) Import new certificates on the card, and optionally, if the certificate already exists on the card, the user is informed that the current resident certificate will be deleted from the card before the operation proceeds;

(d) Perform Certificate Deletion—when a digital certificate is identified to be deleted, the user must optionally but advantageously provide authentication before such deletion is permitted. The certificate data is erased from the card storage. Thereafter the digital certificate state is marked as “erased”; and

(e) Change PINs, where PIN changing may be configured so that such changes do not require exclusive access to the reader.

With further reference to FIG. 17, an exemplary Interaction with Card Control Manager for Keys and Certificate Management is now described. In one non-limiting example, all functionalities available for normal digital certificates are available via the Card Control Manager. These functionalities may, for example, include any one or more of the following: View Certificate, Export Certificate, Load Certificate, and Delete Certificate.

Viewing Certificate allows the user to check the issuer, expiry date, validity of Certificate Authority (CA) signature, and other certificate properties. Export Certificate allows the user to save their certificate in a particular selected file format, such as in the “.cer” file format, for transport to or use on another machine. Note that the export certificate function may optionally but advantageously include any off-line certificates (certs). Load Certificate is a procedure for loading a digital certificate that is Distinguished Encoding Rules (DER) encoded. Delete Certificate allows the user to delete their certificates, and a warning that the corresponding certificate key will also be deleted is optionally but advantageously displayed and the user is asked to confirm.

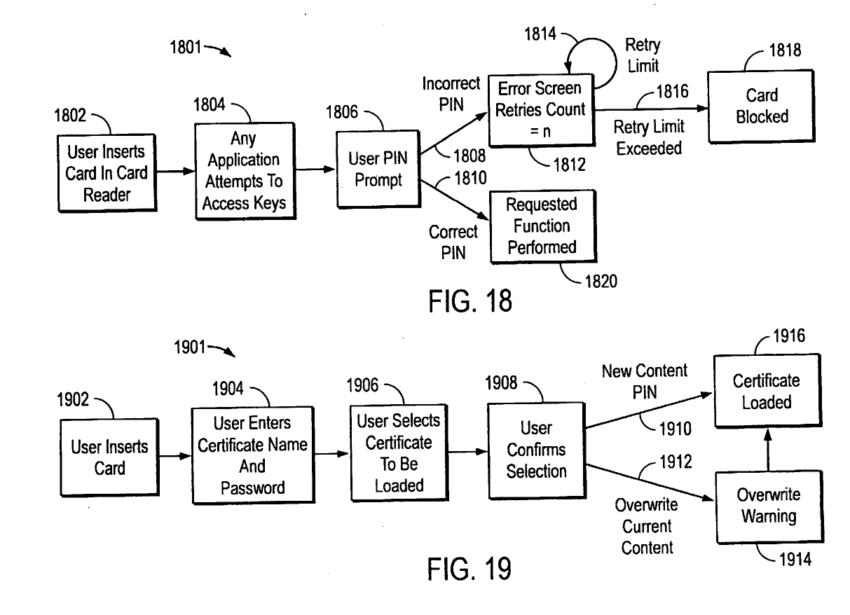

An exemplary embodiment of the method or process flow for a customer (via a client device and client application) seeking to access the payments portal using a digital certificate stored on a smart card or other authentication token or secure storage device is now described relative to the example in FIG. 18.

The client application interaction process flow 1801 begins when the user insert the membership or credit card or other authentication token into the reader/writer device (Step 1802), such as into the smart card reader/writer device when the authentication token is a smart card. When any application attempts to access security keys, such as when a client application requests access to the private key stored on the smart card (Step 1804), the user is prompted for the personal identification number or PIN (Step 1806) or other symbolic security entry. The client application may, for example, be an email client software that supports secured email or other secured communications or transactions. Entering an incorrect PIN (Step 1808) results in an error screen or message that may also optionally show the permitted number of retries before the card is blocked due to incorrect PIN entry attempts (Step 1812). The user may be allowed to retry entering 1814 their PIN a predetermined number of times before the card is blocked. This is of course to prevent random or systematic retries that may, after a very large number of tries, result in successful entry and access. The blockage may be temporary or permanent depending upon established rules and policies. If the permitted retry limit is exceeded, the card is blocked (Step 1818). Entering a correct PIN allows the requested access or function to be performed (Step 1820).

Exemplary embodiments of process and function 1901 for certificate loading and key loading are now described relative to FIG. 19. The first step of the load certificate function or process 1000 is for the user to insert the card (Step 1902), next the user enters the certificate name and password (if required) (Step 1904) and the digital certificate file to be loaded (Step 1906) and then the user confirms the selection (Step 1908). In at least one embodiment, the password field supports alphanumeric characters. In case there are multiple certificates available, a select screen is presented to the user. A confirmation screen is shown (Step 1908) to the user. If current content on the card is being overwritten, a warning is optionally but advantageously displayed (Step 1914) to the user. The user ultimately confirms the selection such as for example to provide a new content PIN after which the Certificate is loaded (Step 1916) or the user confirms the overwrite of a current content on the card, agrees to an overwrite warning (Step 1914) and then the Certificate is loaded onto the card (Step 1916).

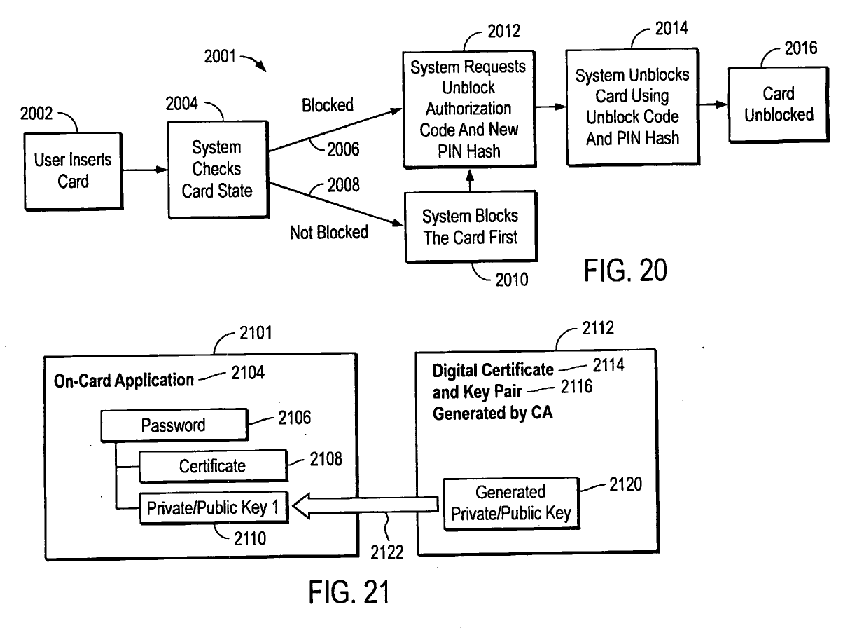

An exemplary embodiment of a user interaction for card unblocking and loading application code onto card 2001 is now described relative to FIG. 20. The card (or other authentication token) may usually be put in a blocked state (so that it cannot be used) if the number of unsuccessful PINs exceeds the maximum number as specified in the PIN policy. The card may only be unblocked by the system administrator using the unblock card function or equivalent car unblocking process.

The user first inserts the card into the special card reader/writer device (Step 2002). The system checks the state of the card (Step 2004) to determine if the card is in a blocked state or in an unblocked state. If the card is in a not blocked or unblocked state, then the system blocks the card first (Step 2010) and then the system requests an unblock authorization code and a new PIN hash (Step 2008). If in checking the card state, the state is determined to be blocked, then the system requests an unblock authorization code and a new PIN hash (Step 2012) directly. Therefore in either case, the system requests an unblock authorization code and a new PIN hash and then the system unblocks the card using the unblock code and PIN hash (Step 2014). The card is then in an unblocked state and may be used (Step 2016).

The Card Control Manager may also generate protected on-card data or information for each applicant based on his/her name and/or other unique identifier. In one exemplary non-limiting embodiment, the process logic (which may include hardware, firmware, software, or any combination of these types of logic) includes:

1. First Logic to embed data, such as logic to write or embed the following data or Null on-card data to generate the protected application codes containing:
i. Digital Certificate, or null if unavailable.
ii. Digital Certificate Password, or null if unavailable.
iii. Card PIN.
iv. Card Holder Name.
v. Card Reference Number (or a unique identifier)
vi. Card Type
vii. PIN Reference Number

2. Second Logic to perform the following checking procedures:
i. Check if the storage medium is inserted.
ii. Check if the storage medium is ready for writing.
iii. Check if the storage medium is blank before writing.

3. Third Logic to write or embed the protected application codes onto the card.

Recall that the system and system process may be described from either of two alternate perspectives, including from the perspective of a user interaction model, or from the system architectural model perspective which describes the system and processes that are required for the operation of the system including the card and software issuance operations. This section also describes embodiments of the operational processes of issuing cards to a cardholder and unblocking the cards of users that have become blocked for some reason, including for having exceeded the number of PIN input or other access retries as described hereinbefore.

We first address the data specification and an exemplary embodiment of a logical data structure and a logical data model that is adapted capture and describe the data entities of the system and their relationship to each other.

It may be appreciated in light of the description provided herein, that the inventive Card Control Manager is not a typical data processing or information management system. In some respects, it may be considered as a middleware application that enables other business or information systems to be built around it to achieve a business objective, but in other ways it is still unique. Considered as such middleware, a typical entity-relationship model or more generally information model for the card control manager is not applicable.

In its role as an enabler middleware application set, Card Control Manager includes a set of Application Program Interfaces (API's) that abstract out the physical characteristics and details of the underlying system for application developers and third parties.

An exemplary on-card application 2104 is now described with reference to FIG. 21 which shows a static structure of the on-card applications, including an on-card Application with password storage 2106 and optional logic associated with a password, an on-card certificate storage 2108 and optional logic associated with a certificate, and an on-card private/public key storage 2110 and optional logic associated with a private/public key.

The on-card application 2104 may interact with a Certificate Authority (CA) 2112 that generates a Digital Certificate 2114 and Private/Public Key pair 2116, 2120 and may provide it to the on-card private/public key storage and optional logic 1204 associated with a one or more key send over a communication channel or link 1215.

The on-card application 2104 may advantageously have the capacity to store at least a single digital certificate and the public/private key pairs for that at least one single digital certificate at any time. Padding for these operations may advantageously adhere to the PKCS #1 (v1.5) standard, which is hereby incorporated by reference, with the additional preference that a minimum of eight bytes of non-zero random padding be used as recommended in version 2.0 of the standard, which version 2.0 is also incorporated by reference herein. It will be appreciated that conformance to a particular standard is not a requirement of limitation of the present invention and that the invention is compatible with various standards and non-standards. It may also be appreciated that as various standards, such as for example one or more of the PKCS standards evolve or change, that the invention and embodiments thereof may be modified to interoperate with or among those standards and that it would be within the still in the art to modify embodiments of the invention described herein to continue to interoperate and be compatible with such improvements, enhancements, and revisions of standards existing as of the time of filing of this application.

Aspects of a non-limiting embodiment of an application module design and system architectural and design features related to security are now described. These features may include the following which are described in greater detail herein below: (i) card issuance policies, (ii) certificate loading card check, (iii) card unblocking, (iv) PIN restrictions for on-card applications, (v) PIN protected versus unprotected on-card resources, and (vi) data, including any default data.

In one non-limiting embodiment, the card and system will provide for certain card issuance policies. For example, at the time of issuance, the card issuer will initialize the card to an unblock state. Part of issuance will be to determine what PIN policies to set for the card. These can include policies pertaining to: number of retries permitted, number of unlocks permitted, whether unblocking is permitted or not permitted, and/or other policies that the card issuer chooses to implement.

Aspects of certificate loading card check are now described. According to one non-limiting embodiment, the certificate loading process performs three checks prior to loading the certificate. Firstly it checks to ensure that the identity contained in the certificate matches the card holder. This may be done by storing the hash of the name of the cardholder in the smart card chip and then comparing this value with the identity on the certificate. If the hash values do not match, then the holder of the card is not the same as the identity on the certificate and the certificate will fail to load.

The second check compares the issuer of the certificate (i.e. the recognized CA) to a value stored protected in the Card Control Manager. This second check ensures that only certificates issued by the intended issuer are accepted. The CA issuer certificate is held in a configuration file that is protected by asymmetric encryption. The private key is securely held by the software vendor and used to encrypt the configuration file. The public key is stored obfuscated in the Card Control Manager and used to decrypt the configuration file during certificate loading. Public key obfuscation in the Card Control Manager may for example be accomplished by storing the configuration file in a hidden directory under the installation directory of CCM, or in other ways known in the art. Once the configuration file is decrypted, the configuration file contains the issuer certificate which can then be checked against the issuer of the certificate being loaded. If the two do not match, the certificate will fail to load (or be prevented from loading).

The third check verifies the type of the certificate. The organisation variable (OV) in the Distinguished Name (DN) string (i.e., Subject) must match the corresponding string read from the configuration file or the certificate will fail to load (or be prevented from loading).

Certificate checking may advantageously be performed at the initialisation of the Cryptographic Service Provider (CSP), and Cryptographic API (CAPI) interfaces, each of which are Microsoft standards and known in the art.

In one non-limiting exemplary embodiment, card unblocking is used to reset a blocked card. A card may be blocked so that it cannot be used after some predetermined or dynamically determined number of tries and retries. In one embodiment, the card is blocked after 3 total tries, in another embodiment, the card is blocked after 5 total tries and retries. Other embodiments of implementations may use a different number of initial tries and retries before blocking the card. A system administrator or card issuer will be able to unblock the card if it is blocked after the predetermined or dynamically determined unsuccessful password or PIN entry attempts.

In at least one non-limiting embodiment, PIN restrictions are employed, where a PIN to access private information is restricted by the Card Control Manager. In one non-limiting embodiment, only numeric PINs may be used by the Card Control Manager for PIN to access private information because under certain scenarios only numeric keypads are available for the cardholder to type in the PIN. In another embodiment, alphanumeric or other symbolic PINs may be used by the Card Control Manager for PIN to access private information even though this is disadvantageous because a full size keyboard must be available. The on-card application may allow alphanumeric PINs or may be restricted to numeric PINs only.

Embodiments of the invention may provide for PIN protected versus unprotected on-card resources. The following Table I summarises the protected versus unprotected resources on the card according to one non-limiting embodiment of the invention.

TABLE I
Exemplary PIN Protected Versus Unprotected On-Card Resources

| Read | Write | |
|---|---|---|
| Permission | Permission | Resources |
| Yes | Yes | Key labels Card Labels |
| Yes | No | Password Policy, Password Counters, Card |
| | | Holder Name Hash, Unblock Serial Number |
| Protected | Protected | Public Key |
| Protected | Protected | Certificates |
| No | Protected | Private Key, PIN Hash, Unblock Hash |

On-card resources may include for example, Key labels and/or Card Labels for which are typically granted read and write permission and are not protected. Key labels and/or Card Labels may for example be any alphanumeric name to identify storage field of private-public key and/or digital certificate.

Password Policy, Password Counters, Card Holder Name Hash, Unblock Serial Number may also be on-card resources, and these my typically have a read permission but no write permission. Password policy may, for example be a retry limit, a minimum password length and a maximum password length. Password counters may, for example be a number of failed attempts, and a retries remaining. Card holder name hash may, for example be the hash value of the concatenation of cardholder's name and ID number. Unblock serial number may, for example be a program generated unique reference number that linked with a new PIN. The new PIN is sealed in an envelop unseen by card issuer. The envelope is then mailed or handed to cardholder. Another on-card resource may be the public key and the certificates. Each of these is protected, which means read or write are only permitted when correct PIN is entered. The private key, PIN hash, unblock hash are other on-card resources where write permission is protected and no read permission is normally granted. The private key is stored in EEPROM or other storage in the card application data segment and is used for digital signing and encryption/decryption of hash value of any text or data on card. A third party application is not permitted to read the private key data directly. The PIN hash is stored in EEPROM or other storage in the card application data segment, and is used to compare the hash of a challenge password. If they match, a flag is set in memory (typically in RAM) indicating the password is valid. The unblock hash is hash of the unblock serial number stored in EEPROM or other memory in the card application data segment and is used to verify the authorization of unblocking the PIN.

In at least one non-limiting embodiment, the PIN policy may be stored on the inventive smart card. Table II identifies some of the data attributes that may be stored either as default data values or by specifically setting such data values. It will also be appreciated that the default values may be different for different cards, different types or cards, different application scenarios, or according to other rules or policies.

TABLE II
Exemplary Data Elements and Element Attributes

| Element | Length | Value | Notes |
|---|---|---|---|
| Unblocking | 1 | variable | Maximum number of incorrect unblock code |
| Code Maximum | | | entries allowed before the unblock code |
| Retry Counter | | | becomes blocked. Suggested default value is 3. |
| Unblocking | 2 | variable | Number of correct unblock code entries |
| Code | | | remaining. When this value reaches zero, no |
| Presentation | | | more unblocks are allowed. |
| Remaining | | | |
| Counter | | | |
| Password | 1 | variable | Maximum number of incorrect password entries |
| Maximum Retry | | | allowed before the password becomes blocked. |
| Counter | | | Suggested default value is 5. |
| Password | 2 | variable | Maximum number of correct password entries |
| Maximum | | | remaining before the password must be changed. |
| Presentation | | | It can be set to unlimited in which case the user |
| Counter | | | will never be prompted to change their password. |

An Unblocking Code Maximum Retry Counter (UCMRC) element is an element that identifies the maximum number of incorrect unblock code entries allowed before the unblock code becomes blocked. In one non-limiting embodiment, the value is variable and may have a length of 1 character. In one non-limiting embodiment, the suggested or default value is 3.

An Unblocking Code Presentation Remaining Counter (UCPRC) element is an element that identifies the number of correct unblock code entries remaining. When this value reaches zero, no more unblocks are allowed. In one non-limiting embodiment, the value is variable and may have a length of 2 characters.

A Password Maximum Retry Counter (PWMRC) element is an element that identifies the maximum number of incorrect password entries allowed before the password becomes blocked. In one non-limiting embodiment, the value is variable and may have a length of 1 character. In one non-limiting embodiment, the suggested or default value is 5.

A Password Maximum Presentation Counter (PWMPC) element is an element that identifies the maximum number of correct password entries remaining before the password must be changed. It can be set to unlimited in which case the user will never be prompted to change their password. In one non-limiting embodiment, the value is variable and may have a length of 2 characters.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best use the invention and various embodiments with various modifications as are suited to the particular use contemplated. It is intended that the scope of the invention be defined by the claims appended hereto and their equivalents.

We claim:

1. A system for making and accepting payments in an on-line network transaction between a first and second parties, the system comprising:
an on-line networked transaction server coupled with a tangible storage device in which a subscriber data structure is defined and which stores transaction portal subscriber information;
the transaction server configured to communicate via the network with an issuer of digital certificates and with an issuer of bank cards;
the issuer of bank cards configured to communicate via the network and issuing bank cards having an integrated circuit defining a memory for storing a digital certificate and processing logic for protecting the memory from unauthorized access; and
the issuer of digital certificates configured to communicate via the network and issuing digital certificates that are associated with a identifier (ID) and maintaining a certificate database storing issued digital certificates and digital certificate status.

2. A system as in claim 1, wherein the system further comprises a bank server associated with the issuer of bank cards.

3. A system as in claim 1, wherein the system further comprises a certificate authority server associated with the certificate authority.

4. A system as in claim 1, wherein the issued bank cards further including a certificate loader control logic for controlling the writing of the digital certificate to the bank card.

5. A system as in claim 1, wherein the first and second parties comprise first and second transaction portal subscribers comprise a payor and a payee.

6. A system as in claim 1, wherein the subscriber information comprises payor and payee subscriber information.

7. A system as in claim 1, wherein the system further comprises the issuer of digital certificates and the issuer of bank cards.

8. A system as in claim 1, wherein the integrated circuit defining a memory for storing a digital certificate and processing logic for protecting the memory from unauthorized access stores a cryptographic hash of the identifier and optionally of other information.

9. A system as in claim 1, wherein the identifier comprises a personal, merchant, business, utility, organizational, or governmental identifier.

10. A system as in claim 1, wherein the digital certificate status is selected from the set of status types consisting of at least one of a valid status, an invalid status, a revoked status, and a suspended status.

11. A system as in claim 1, wherein the certificate loader control logic comprises an application certificate loader software or firmware loaded on the bank card that is particularized to the identity of the owner of the digital certificate that is loaded onto the bank card.

12. A system as in claim 1, wherein at least one of the digital certificate issuing certificate authority and the bank card issuer bank provide a certificate status update to alter the digital certificate status over the network without the involvement of the owner of the digital certificate.

13. A system as in claim 1, wherein the transaction server establishes separate relationships between the first and second parties and the first and second parties do not need to have a separate prior transaction to conduct an on-line transaction with each other through the transaction portal.

14. A system as in claim 1, wherein the transactions between the first and second parties are performed in a closed-loop digital certification environment where first and second party identity and digital certificate validity status are tested at each stage of the transaction before the transaction is permitted to go to completion.

15. A system as in claim 1, wherein the transaction portal maintains an electronic log of the transaction so that the transaction may be verified and not be subject to repudiation by either the first party or the second party.

16. A system as in claim 1, wherein the transaction portal collects a financial remuneration or fee from at least one of the first and second parties for each transaction concluded.

17. A system as in claim 1, wherein the first party and/or the second party communicate with the network by one of a personal computer, a PDA, a cellular telephone, a public information terminal, and an information appliance.

18. A computer implemented method for making and accepting payments in an online network transaction, the method comprising:
at a network on-line transaction portal, receiving a transaction instruction from a first party regarding an action to be taken relative to a second party;
verifying with a certificate authority database in substantially real time that both the first party and the second party have currently valid digital certificates issued by a recognized digital certificate authority and associated with their unique identifier;
verifying with a financial institution in substantially real time that the first party and the second party are capable of completing the transaction instruction; and
maintaining an electronic transaction log to document the transaction and mitigate attempted repudiation of the transaction by the first party or the second party.

19. A method as in claim 18, wherein the transaction instruction comprises a payment instruction.

20. A method as in claim 18, wherein first party is a buyer or payor.

21. A method as in claim 18, wherein the first party is an individual person and the second party is a merchant organization.

22. A method as in claim 18, wherein the first party is an individual person and the second party is a governmental entity.

23. A method as in claim 18, wherein the certificate authority is a governmental entity.

24. A method as in claim 18, wherein the second party is a seller or payee.

25. A method as in claim 18, wherein the verifying that both the first party and the second party have currently valid digital certificates issued by a recognized digital certificate authority are completed in substantially real-time by accessing a CDL LDAP database.

26. A method as in claim 18, wherein the transaction is a purchase of goods and/or services, and the first party has sufficient documented monetary resources to purchase the goods and/or services, and the second party has a documented ability to sell the contracted for goods and/or services.

27. A computer implemented method of issuing a digital security and authentication certificate, comprising:
opening, by a certificate issuing authority, over a computer interface, an interface with a network server, to initiate a certificate issuance application;
inputting an identification information of the applicant;
generating a key pair including a private key and public key and an applicant specific digital certificate for the applicant;
storing the digital certificate into a tangible computer or machine readable storage medium; and
after successful issuance of the certificate, publishing the corresponding public certificate to a certificate repository.

28. A method as in claim 27, wherein: the identification information comprises a name and/or identification (ID) number.

29. A method as in claim 27, wherein: the digital certificate is a PKCS#12 and PKCS#11 compatible format.

30. A method as in claim 27, wherein: the digital certificate is a PKCS#12 and PKCS#11 format.

31. A method as in claim 27, wherein: the tangible computer or machine readable storage medium is selected from the set consisting of a floppy disk, electronic certificate File Card, a smart card, a USB storage module, a semiconductor storage device, or other memory device.

32. A method as in claim 27, further comprising: deleting or erasing the digital certificate from storage other than the a tangible computer or machine readable storage medium onto which it was stored.

33. A method as in claim 27, wherein: the certificate repository is a Lightweight Directory Access Protocol (LDAP) repository.

34. An authentication token apparatus comprising:
an integrated circuit having a processing logic unit and a storage unit coupled to the processing logic unit;
a substrate for carrying the integrated circuit;
the storage unit storing a certificate loader and control program comprising a plurality of certificate loader and control executable instructions; and
the plurality of certificate loader and control executable instructions being operable to cause the integrated circuit to interact with the authentication token control manager (card control manager) executing in the computer or information appliance.

35. An apparatus as in claim 34, wherein the authentication token comprises a smart card or a SIM card.

36. An apparatus as in claim 34, wherein the storage unit further storing a hash value of a digital certificate.

37. An apparatus as in claim 34, wherein the information from the electronic certificate memory or SIM card is retained in an internal non-volatile memory of the read/writer device so that the certificate information may be embedded on additional membership cards as the internal memory may be non-volatile memory.

38. An apparatus as in claim 34, wherein the information from the electronic certificate memory or SIM card is not retained in an internal non-volatile memory of the read/writer device or the internal memory is configured as a volatile memory so that the information from the electronic certificate memory or SIM card is not retained.

39. An apparatus as in claim 34, wherein the information from the electronic certificate memory or SIM card is automatically cleared when the device is disconnected from a power source or the powered USB interface.

40. An apparatus as in claim 34, wherein the information from the electronic certificate memory or SIM card is automatically cleared or deleted on the command of the cardholder user or under programmatic control.

41. An apparatus as in claim 34, wherein a synergistic combination of the Card Control Management software and its executable instructions, a USB-interface based dual-media reader/writer, and the embedding of the smart card with the certificate loader and control program, provides an operating system and environment with novel and unique features and capabilities.

42. A device for performing a reading and/or writing operation for two objects each of which has a memory storage, the device comprising:
a first physical connector for electrically interfacing with a first object or media type;
a second physical connector for electrically interfacing with a second object or media type;
a third physical connector for electrically interfacing with a third object; and
a controller unit for enabling and controlling communications between the first, second, and third objects.

43. A device as in claim 41, wherein the first physical connector comprises a SIM card slot for electrically interfacing with a SIM card first object or media type.

44. A device as in claim 41, wherein the second physical connector comprises a smart card slot for electrically interfacing with a smart card first object or media type.

45. A device as in claim 41, wherein the a third object comprises a computer, information appliance or workstation.

46. A device as in claim 41, wherein the a third object comprises USB connector for connecting to an external computer.

47. A device as in claim 41, wherein the controller unit comprises a micro-controller unit (MCU)) for enabling and controlling communications between the first, second, and third objects.

48. A device as in claim 41, wherein the controller unit comprises a micro-controller unit (MCU) for enabling and controlling communications for enabling and controlling communications between a SIM card as the first object, a smart card as the second object, and a computer, information appliance, or workstation as the third object.

49. A device as in claim 41, wherein the third physical connector comprises a USB connector.

50. A device as in claim 41, wherein the device comprises a USB hub for connecting and enabling communication between and among the computer, information appliance, or workstation that may be connected thereto and the SIM card (or other first object or media type) and the smart card (or other second object or media type).

51. A device as in claim 41, wherein the controller provides the internal memory used when copying and/or converting the digital certificates between the first object or first media type and the second object or second media type.

52. A device as in claim 51, the controller provide the only internal memory used when copying or converting the digital certificates between the first object or first media type and the second object or second media type, and the controller protects the internal memory from reading, writing, or interrogation from an unauthorized agent.

53. A device as in claim 51, wherein the digital certificates may be deployed to the authentication token media as wither PKCS#11 and PKCS#12 format.

54. A method for using unique digital values to prevent fraudulent access or use of an authentication token embedded with a security digital certificate, the method characterized in that a cryptographic hash value of that ID includes hashing a unique user ID is stored on the token and when the internally stored hash is accessed by a user password or PIN, a comparison of the stored hash value against the user ID is made to determine a match before access is permitted.

55. A device for using unique digital values to prevent fraudulent access or use of an authentication token embedded with a security digital certificate, the device characterized in that a cryptographic hash value of that ID includes hashing a unique user ID is stored on the token and when the internally stored hash is accessed by a user password or PIN, a comparison of the stored hash value against the user ID is made to determine a match before access is permitted.
